(19) United States
(12) Patent Application Publication
(10) Pub. No.: US 2012/0154355 A1
(43) Pub. Date: Jun. 21, 2012

(54) IMAGE DISPLAY APPARATUS

(75) Inventors: Takashi Kawai, Yokohama-shi (JP); Jun-ichi Machida, Saitama-shi (JP); Satoru Komatsu, Yokohama-shi (JP)

(73) Assignee: CANON KABUSHIKI KAISHA, Tokyo (JP)

(21) Appl. No.: 13/391,985

(22) PCT Filed: Nov. 17, 2010
(86) PCT No.: PCT/JP2010/070956

§ 371 Date: Feb. 23, 2012

(30) Foreign Application Priority Data
Nov. 27, 2009 (JP) 2009-270631
Nov. 27, 2009 (JP) 2009-270632

(51) Int. Cl. G09G 5/10

(52) U.S. Cl. 345/207; 345/690

(57) ABSTRACT

An image display apparatus is provided that avoids discontinuity in a high luminance and gradation range and is capable of displaying gradations where differences in sense of luminance change at equal intervals from an intermediate gradation range to the maximum value of the gradations. A gradation/light emission luminance converter 104 converts the gradation of an input image into data corresponding to a luminance to be displayed by a video light emitter 107 using predetermined conversion characteristics. In an intermediate gradation range, the common logarithms of the luminances to be displayed by the video light emitter 107 have a proportional relation to the gradations. In the high luminance and gradation range, the relation gradually deviates from the proportional relation; the nearer the gradation approaches the maximum value thereof, the larger the variation quantity of the common logarithm of the luminance to be assigned to an increment of the gradations becomes.

### TECHNICAL FIELD

The present invention relates to an image display apparatus that displays gradations of an image by luminance, and more particularly, to control of correcting a relation between a gradation of an image and a luminance of displaying in conformity with visual characteristics of humans.

### BACKGROUND ART

A range of luminance (illuminance) discriminable to humans existing in the natural world extends over a wide range, from 1×10⁻³ to 1×10⁵ lx. It is said that humans sense a luminance as a magnitude proportional to the common logarithm of an actual luminance. Accordingly, conventional image display apparatuses, such as a CRT, a liquid crystal display, a plasma display and an organic EL display, assign a luminance of the displaying for each pixel such that the common logarithm of a luminance to be displayed on an image displaying unit has a proportional relation with a gradation of an input image.

However, the nearer the luminance approaches the lowest limit discriminable to humans, the more difficult it becomes to discriminate the luminance differences of pixels in a simple proportional relation. A technique has been proposed that assigns increments discriminable as equal intervals in a range displayable by the image display apparatus to gradations in conformity with such a human visual characteristic (NPL 1). A standard for medical displays is provided by the National Electrical Manufactures Association based on this technique. Image display apparatuses employing gradation-luminance converting characteristics according to this standard are on the market. The name of the standard is the GSDF (grayscale standard display function) of the DICOM (digital imaging and communications in medicine).

As illustrated in FIG. 22, in this standard, the basis thereof is that the common logarithm of a luminance of the displaying to be displayed on the image displaying unit has a proportional relation to a gradation of a pixel of an input image; thereupon, the nearer the gradation approaches the minimum value thereof, the larger the variation quantity of the common logarithms of the luminances assigned to increments of the gradations becomes.

The inventors of the present invention have found that the ability for humans to discriminate variations or differences of luminance has a certain range and the ability is decreased at a too low luminance incident into vision and also at a too high luminance. Further, the inventors have found that this phenomenon appears in a high luminance range of an image display apparatus having already been in practical use.

On the other hand, in GSDF characteristics of DICOM, the proportional relation of the common logarithm of a luminance to a gradation of a pixel of an input image is substantially maintained even in a range of a high luminance range exceeding 1×10³ cd/m². Accordingly, it has been found that, in an image display apparatus employing the GSDF characteristics of DICOM, the gradation of the high luminance and gradation range is indiscriminable in change of gradations owing to reduction in luminance difference discriminating ability with respect to a change of an image signal in comparison with an intermediate gradation range, thus causing a phenomenon that seems to be flat.

### CITATION LIST

### Patent Literature

PTL 1: Japanese Patent Application Laid-Open No. 2001-309280
PTL 2: Japanese Patent Application Laid-Open No. H08-146921
PTL 3: Japanese Patent Application Laid-Open No. H06-169437

### Non Patent Literature

NPL 1: Digital Imaging and Communications in Medicine (DICOM). Part 14—Grayscale Standard Display Function, National Electrical Manufactures Association

### SUMMARY OF INVENTION

The present invention is directed to an image display apparatus that avoids flattening of gradations in a high luminance and gradation range and is capable of displaying gradations where a difference in sense of luminance changes at equal intervals from the intermediate gradation range to the maximum value of the gradation.

According to the present invention, an image display apparatus comprises: a display unit; and a gradation conversion unit for a conversion processing to correlate a gradation of an input image with a luminance of a displaying by the display unit, according to a predetermined conversion characteristics. And, the gradation conversion unit performs the conversion processing such that, when the luminance of the displaying by the display unit is evaluated based on a common logarithm, in a high luminance and gradation range, as the gradation of the input image increases toward a maximum value, a variation of the luminance of the displaying by the display unit based on the common logarithm corresponding to a variation of the gradation of the input image increases, so as to be shifted from a relation between the gradation of the input image and the luminance of the displaying in an intermediate luminance and gradation range.

The image display apparatus of the present invention performs a conversion processing such that, the nearer a changing quantity of the common logarithm of the luminance to be assigned to the increment of the gradation approaches the maximum value of the gradation, the larger the changing quantity becomes. Accordingly, reduction in human ability of discriminating the variation quantity of the common logarithm of the luminance in the high luminance and gradation range can be compensated. Therefore, the gradation-display luminance converting characteristics in the high luminance and gradation range is adapted to human sense characteristics, thereby allowing the difference in luminance with regard to the increment of the gradation of the input image to be sensed at equal intervals up to the maximum value of the gradation. Thus, flattening of the gradations in the high luminance and gradation range is avoided and high quality gradations where a difference in sense of luminance changes at equal intervals from the intermediate gradation range to the maximum value of the gradation can be displayed.

### BRIEF DESCRIPTION OF DRAWINGS

FIG. 1 is a diagram of a configuration of a video display apparatus of an example.

FIG. 2 is a diagram of luminance discriminability threshold contrast characteristics with respect to incident light luminances.

FIG. 3 is a diagram of visual stimulating light luminance characteristics with respect to JND index.

FIG. 4 is a diagram of luminance difference discriminability threshold characteristics with respect to stimulating light luminances.

FIG. 5 is a diagram of light emitting luminance characteristics with respect to input signal levels.

FIG. 6 is a signal conversion quadrant diagram from input of a video signal to light emitting.

FIG. 7 is a diagram of luminance discriminability threshold contrast characteristics with respect to incident light luminances in Example 2.

FIG. 8 is a diagram of visual stimulating light luminance characteristics with respect to JND index in Example 2.

FIG. 9 is a diagram of light emitting luminance characteristics with respect to input signal levels in Example 2.

FIG. 10 is a diagram illustrating coefficients for the Stevens' power Law Equation.

FIG. 11 is a diagram illustrating the Stevens' power Law.

FIG. 12 is a diagram illustrating the Stevens' power Law, where an adapting luminance level is 1.0 cd/m².

FIG. 13 is a diagram where FIG. 12 is represented in a logarithmic scale.

FIG. 14 is a diagram where the ordinate and the abscissa of FIG. 12 are replaced with each other and the ordinate is represented in a logarithmic scale.

FIG. 15 is a block diagram illustrating a configuration of a video display apparatus according to Example 3.

FIGS. 16A, 16B and 16C are schematic diagrams illustrating a relation between luminances of light incident in the eyes and luminance difference discriminability threshold contrast.

FIG. 17 is a flowchart illustrating an operation of a unit setting light emitting luminance characteristics according to Example 3.

FIGS. 18A and 18B are schematic diagrams illustrating light emitting luminance characteristics.

FIG. 19 is a block diagram illustrating a configuration of a video display apparatus according to Example 4.

FIG. 20 is a flowchart illustrating an operation of a unit setting light emitting luminance characteristics according to Example 4.

FIG. 21 is a diagram illustrating a method of interpolating light emitting luminance characteristics according to Example 4.

FIG. 22 is a diagram illustrating GSDF characteristics of DICOM.

FIG. 23 is a diagram illustrating the Weber-Fechner Law.

FIG. 24 is a diagram of discriminability threshold contrast characteristics with respect to intensities of stimuli concerning GSDF characteristics of DICOM.

FIGS. 25A, 25B and 25C are diagrams illustrating a reason for using common logarithms.

### DESCRIPTION OF EMBODIMENTS

### Embodiment 1

Embodiment 1 of the present invention will hereinafter be described in detail with reference to the drawings. The present invention can be applicable to another embodiment where a part or the entire configuration of Embodiment 1 is replaced with an alternative configuration thereof, only if the nearer the gradation approaches the maximum value thereof, the larger the variation quantity of the common logarithm of the luminance to be assigned to a difference of gradations becomes.

In this Embodiment 1, a video display apparatus only having a displaying function such as a computer display will be described as an image display apparatus. However, a television receiver and electronic viewfinders mounted on a camera and a video camera, which are video display apparatuses including a video and audio receiving unit, also referred to as video display apparatuses. The video display apparatus can be used for an image display apparatus, such as a CRT, a liquid crystal display, a plasma display and an organic EL display.

With respect to the general matters related to the configuration and control of an image display apparatus disclosed in PTL 1, illustration thereof in figures is omitted and redundant description is also omitted.

<GSDF Characteristics of DICOM>

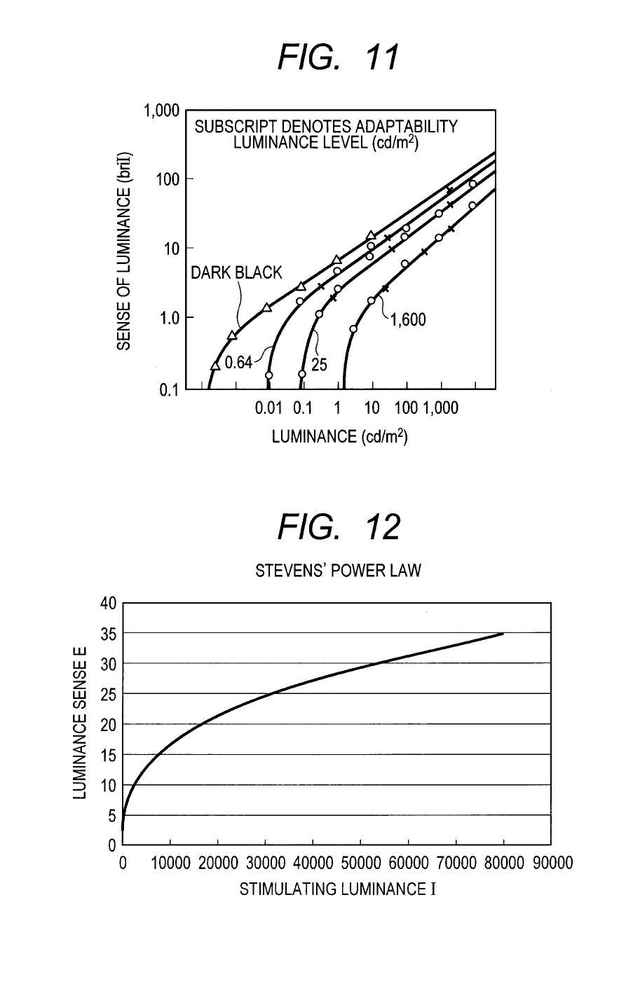

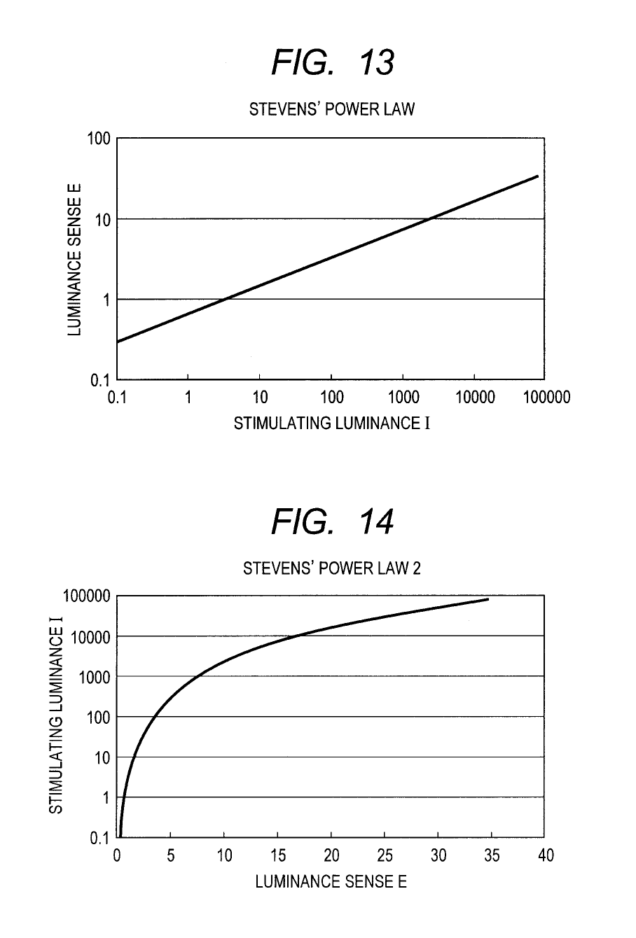

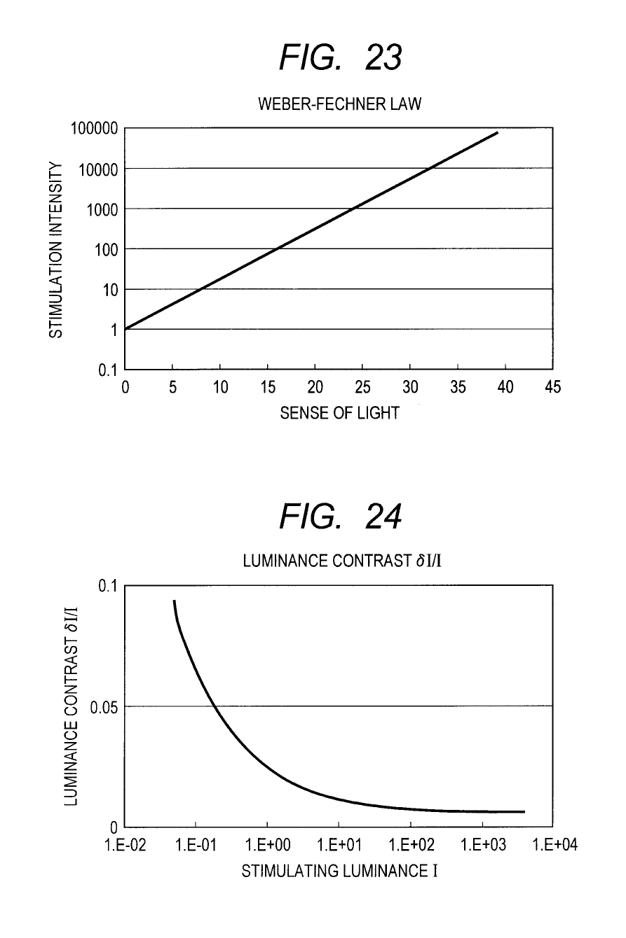

FIG. 10 is a diagram illustrating coefficients for the Stevens' power Law Equation. FIG. 11 is a diagram illustrating the Stevens' power Law (cited from “Disupurei no kiso” (Oishi, Hatada and Tamura (ed.), Kyoritsu shuppan)). FIG. 12 is a diagram illustrating the Stevens' power Law, where an adapting luminance level is 1.0 cd/m². FIG. 13 is a diagram where FIG. 12 is represented in a logarithmic scale. FIG. 14 is a diagram where the ordinate and the abscissa of FIG. 12 are replaced with each other and the ordinate is represented in a logarithmic scale. FIG. 22 is a diagram illustrating GSDF characteristics of DICOM. FIG. 23 is a diagram illustrating the Weber-Fechner Law. FIG. 24 is a diagram of discriminability threshold contrast characteristics with respect to intensities of stimuli concerning GSDF characteristics of DICOM.

When humans observe an object, they receive light from the object observed by their eyes, sense the luminance and color of the object and determine what the object observed is. Even though sense of the light incident in the eyes varies in some degree among individuals, the manner is generally well known as the Weber's Law and the Weber-Fechner Law.

Provided that an intensity of stimulus (intensity of incident light into the eyes) is I and a discriminability threshold (minimum stimulus difference perceivable by humans) with respect to the intensity of stimulus is 61, the Weber's Law is a law indicating that a ratio δI/I of I and δI is constant irrespective of the value I and represented by Equation 1.

$$\begin{matrix}[ Math . 1 ] & \\ \frac{δ I}{I} = constant & ( Equation 1 )\end{matrix}$$

The Weber-Fechner Law is an extension of the Weber's Law. Provided that an intensity of stimulus is I and a perceived quantity with respect to the stimulus is E, the Weber-Fechner Law indicates that “the perceived quantity E is sensed so as to be proportional to the logarithm of the intensity of stimulus I”. (k is a proportionality constant)

[Math. 2]

E=k log I (Equation 2)

On the other hand, the Stevens' power Law indicates that “the perceived quantity E is proportional to a power of the intensity of stimulus I (power coefficient n)” according to an intensity of stimulus I, a perceived quantity is E with respect to the stimulus, and an exponent n dependent on types of senses (here, a sense of luminance with respect to an incident light intensity in the eyes). (k is a proportionality constant)

[Math. 3]

E=kIⁿ (Equation 3)

A video display apparatus assigns a discriminability threshold δI with respect to a displayed light emitting intensity to one gradation of a video signal, and emits light according to one of Equations 2 and 3. Accordingly, it is indicated that luminance sense linear to the gradation of the video signal is acquired. However, on the other hand, it is also well known that the law holds only for a range of intensities of stimuli, which is a relatively narrow extent.

On this point, Stevens extended Equation 3 and reported following Equation 4, where the incident light intensity I into the eyes, the perceived quantity E with respect to stimulus, the power coefficient n and the proportionality constant k are coefficients dependent on an adapting luminance I₀ under an observation visual environment.

[Math. 4]

E=k(I−I₀)ⁿ (Equation 4)

FIGS. 10 and 11 illustrate a relation of coefficients n, k and I₀ of Equation 4 and the incident light intensity I of Equation 4 with respect to a luminance perceived quantity E. In FIG. 10, Lₒ corresponds to I₀ of Equation 4. The luminance perceived quantity in FIG. 11 employs BRIL, which is a subjective luminance scale, as a unit.

Here, when the ambient visual environment is dark black, the exponent n in Equation 4 is n=0.33. The exponent n increases according to increase in adapting luminance level (the ambience becomes bright). The exponent n approaches n=0.5 in a very bright place.

FIG. 12 is a diagram that plots luminance sense with respect to stimulating luminances where n=0.35, k=0.67 and I₀=0.012 under adapting luminance level 1.0 cd/m² illustrated in FIG. 10 and forms an exponential function with exponential coefficient 0.35. FIG. 13 illustrates coordinate axes of the stimulating luminance and the luminance sense represented in logarithmic representations. When logarithms of both sides of Equation 4 are taken, the logarithms of the stimulating luminance and the luminance sense are proportional to each other with a coefficient n as represented by Equation 5.

[Math. 5]

log E∝n log I (Equation 5)

FIG. 14 is a diagram plotting such that luminance sense E is for the abscissa and the stimulating luminance I (logarithmic representation) is for the ordinate. This diagram indicates that the stimulating luminance should be supplied in a relation as in FIG. 14 in order to increase luminance at the sense of sight in a sensorily even manner. Such stimulating luminance is equivalent to the displayed light emitting intensity in a sensorily even and continuous manner with respect to each gradation of even gradation video signals of the video display apparatus.

There have been studies dealing with a relation between the stimulating luminance and the luminance sense in relation to the Stevens' power Law. These are the GSDF (Grayscale Standard Display Function) of Medical Display Standard DICOM (Digital Imaging and Communications in Medicine) by the National Electrical Manufactures Association, and a study by Barten et al., which has been a basis of the standard.

FIG. 22 is a diagram plotting the GSDF disclosed in the DICOM. The ordinate is the displayed light emitting intensity of the video display apparatus. The abscissa is JND (Just Noticeable Difference) index. One step of JND is the discriminability threshold for the light intensity of stimulus described above. A linear relation is held with respect to the luminance sense variation. In this sense, the plot of the luminance sense and the stimulating luminance in FIG. 14 according to Stevens indicates what is the same as the GSDF characteristics in FIG. 22 with respect to human visual characteristics.

In the GSDF characteristics of the DICOM, a proportional relation is held between the video signal and the JND. A video signal to be displayed on a medical display apparatus is linearly assigned to the JND according to bit-depths (the number of video signal bits indicating how many bits the video gradation are represented with) of the video signal, and displayed on a display with light emitting luminance determined by the GSDF characteristics.

FIG. 23 is a diagram plotting the Weber-Fechner Law with coefficient k=8 in Equation 2. The luminance sense E is represented on the abscissa. The intensity of stimulus I is represented on the ordinate with a logarithmic scale. In comparison of FIGS. 23 and 14 with each other, it can be understood that, in an even sense scale, a logarithmic proportional relation is held in the entire range of the Weber-Fechner Law. On the other hand, in the Stevens' power Law and the GSDF characteristics, deviation from linearity is reflected to the logarithms of the stimulating quantities with small perceived quantities.

FIG. 24 is a diagram plotting the GSDF characteristics as δI/I (hereinafter, referred to as a discriminability threshold contrast), which is a ratio between the intensity of stimulus I of Equation 1 and the discriminability threshold δI with respect to the intensity of stimulus. As illustrated in FIG. 24, in the GSDF characteristics, δI/I is not constant in contrast to Equation 1 represented by Weber's Law. In a range with small JND indices (a darkly perceivable range), human sensitivity of luminance difference discriminability is reduced, and the discriminability threshold contrast is increased; the larger the JND index, the higher the sensitivity of luminance difference discriminability becomes and the lower the discriminability threshold contrast becomes. It can thus be understood that the nonlinearity of the perceived quantity and the stimulating quantity is considered.

However, we usually experience that nonlinearity of the perceived quantities exists also in stimulating quantities on a high luminance side. For example, in viewing TV in a room with low light, when a screen illuminance is high (the light emitting luminance incident in the eyes is high), the screen glares and the image is difficult to watch. This is not a phenomenon limited to the room with low light. Recently, also in liquid crystal televisions, the wide dynamic range of light emitting luminance has been increased, and the maximum light emitting luminance has further been increased and the minimum light emitting luminance has further been reduced. Chances that the eyes receive light with high luminance have increased even in a luminance environment in a room in daily life. Moreover, wide dynamic range displays, which have the maximum light emitting luminance much wider than that of commercial consumer televisions in order to enhance presence of video content, are on the market.

In such a video display apparatus, with display characteristics where, the larger the JND index indicated by the GSDF characteristics, the lower the luminance discriminability threshold contrast becomes, there is a possibility of causing a difference with an actual visual characteristics. As a result, this causes a possibility of causing a mismatch of the video signal gradation with the luminance sense.

Thus, in examples which will be described below, luminance discriminability threshold characteristics with respect to the human visual incident light luminance are analyzed in the entire visually acceptable luminance range (visual dynamic range). Correspondence between the perceived quantities (JND index) evenly divided with respect to luminance and the value of light emitting luminance is stored and held over the entire visual dynamic range and gradation-luminance conversion is performed.

### Example 1

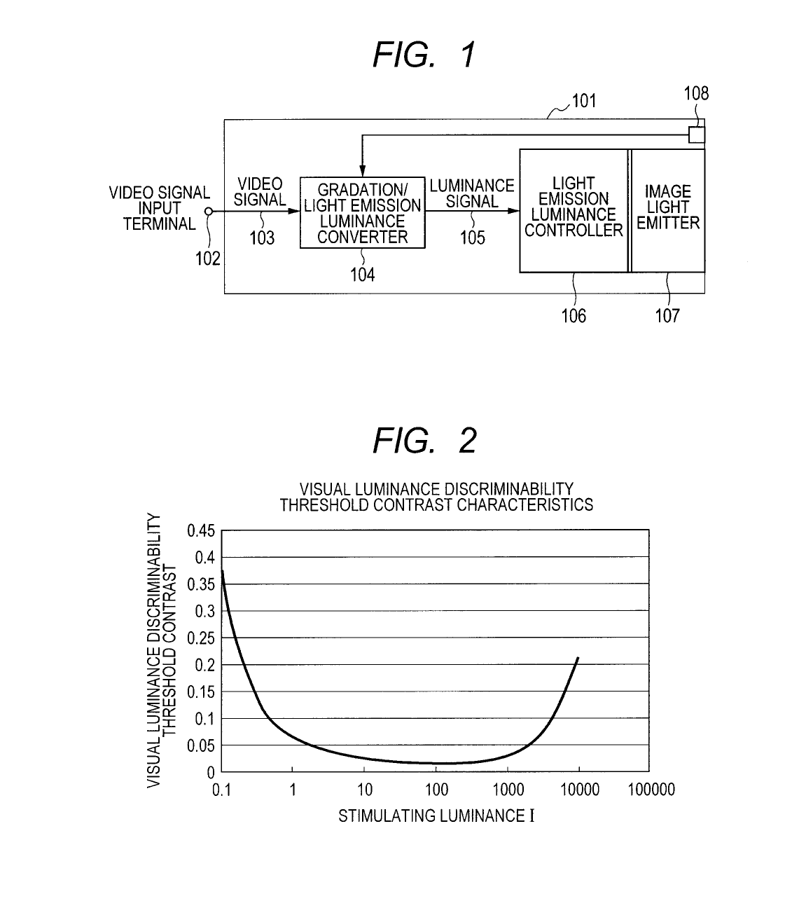

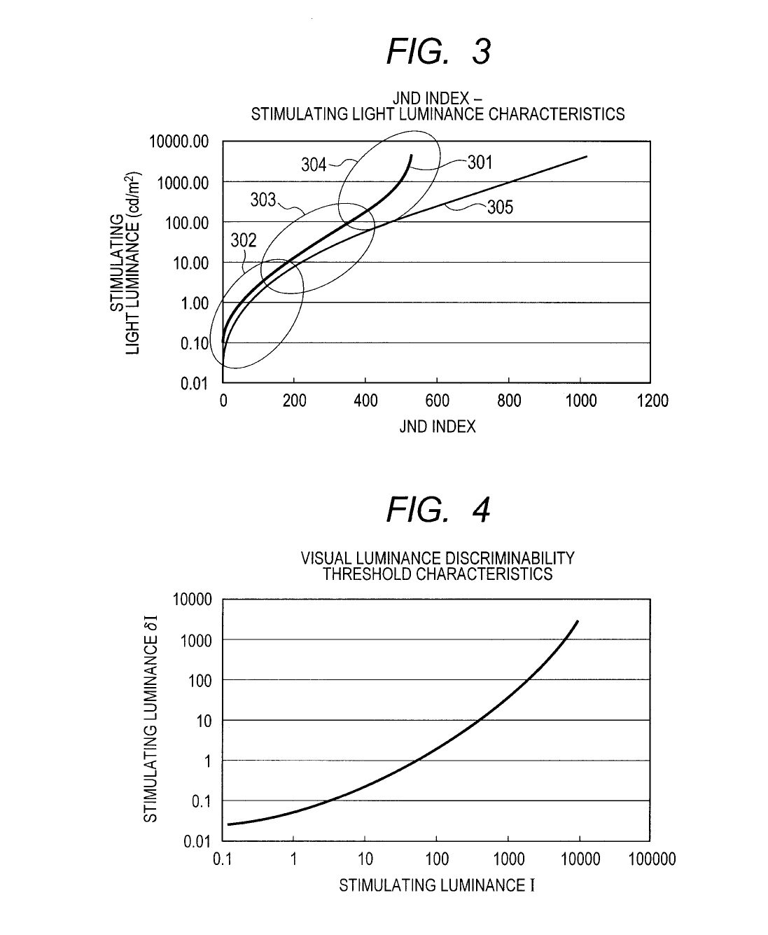

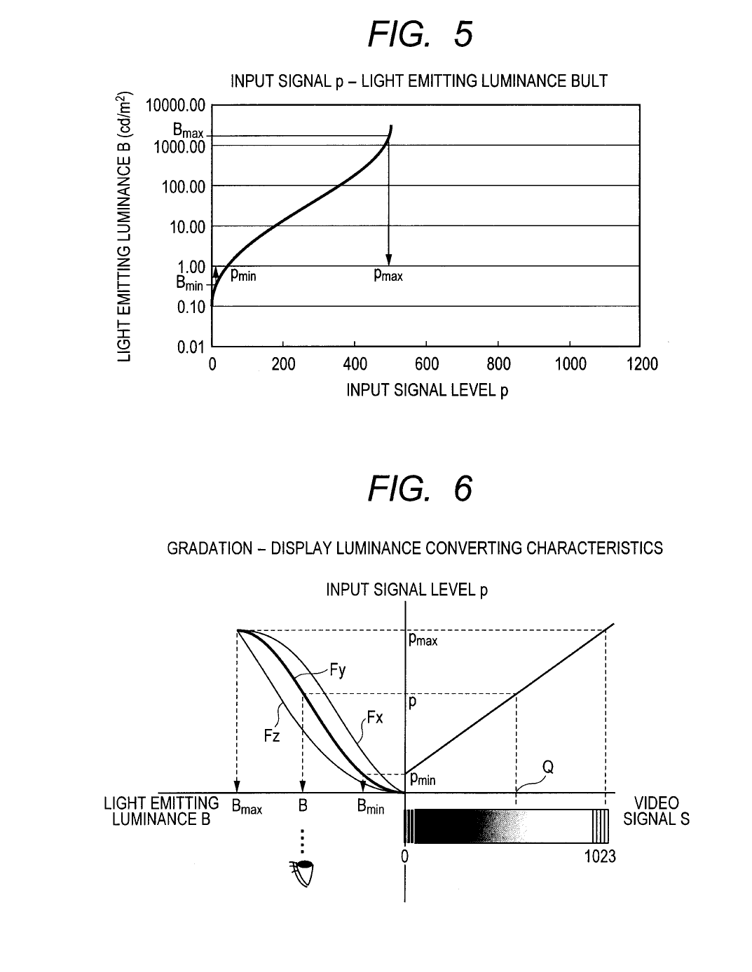

FIG. 1 is a diagram of a configuration of a video display apparatus of an example. FIG. 2 is a diagram of luminance discriminability threshold contrast characteristics with respect to incident light luminances. FIG. 3 is a diagram of visual stimulating light luminance characteristics with respect to JND index. FIG. 4 is a diagram of luminance discriminability threshold characteristics with respect to stimulating light luminances. FIG. 5 is a diagram of light emitting luminance characteristics with respect to input signal levels. FIG. 6 is a signal conversion quadrant diagram from input of a video signal to light emitting.

As illustrated in FIG. 1, in a video display apparatus 101, a video signal transmitted from a video source, which is not illustrated, is captured as a video signal 103 in the video display apparatus 101 via a video signal input terminal 102. The signal format of the video signal 103 may be various depending on types of video sources. In this example, the signal is normalized by a format converter, which is not illustrated, in the video display apparatus 101 into a signal format common to the apparatus. Here, for the sake of simplicity of description, the video signal 103 is a digital signal represented in gradations of ten bits, from 0 to 1023, with no color component but only with a luminance component.

The video signal, 103 is input into a gradation/light emission luminance converter 104. The gradation/light emission luminance converter 104 (gradation converter) converts the gradation of each pixel of an input image into data corresponding to the luminance of the displaying to be displayed on a video light emitter (image displaying unit) 107, using predetermined conversion characteristics. A gradation-display luminance converting LUT (look up table) where input is the 10-bit digital video signal 103 and output is a luminance signal 105 is mounted on the gradation/light emission luminance converter 104. The gradation-display luminance converting LUT is an LUT whose correspondence between input and output has been determined based on human visual characteristics, which will be described below.

The video signal 103 is converted into the luminance signal 105 corresponding to the light emitting luminance value emitted from this apparatus according to the gradation-luminance of the displaying characteristics illustrated in FIG. 6, and output from the gradation/light emission luminance converter 104. The luminance signal 105 is input into a light emission luminance controller 106. The light emission luminance controller 106 controls the video light emitter 107 according to a light emitting system using a liquid crystal display, thereby displaying a luminance value designated by the luminance signal 105. The video light emitter 107 may employ various systems, such as a plasma display and an organic EL display. In this case, the light emission luminance controller 106 is replaced with what controls the light emitting quantity of a pixel according to these light emitting systems.

The flow from input of the video signal to light emission from the video is as described above. Hereinafter, for the sake of simplicity of description, the luminance signal 105 output from the gradation/light emission luminance converter 104 is completely controlled by the light emission luminance controller 106 to cause the video light emitter 107 to emit light at a designated luminance value. The video light emitter 107 includes one of a liquid crystal image panel and a plasma panel; the luminance of the displaying value is linearly changed with respect to the luminance signal 105.

FIG. 6 illustrates a flow of a signal from input of the video signal 103 to emission at a luminance B by the video light emitter 107. The video signal 103 is converted into an input signal P, by a video single S-input single level P converting LUT, according to a characteristic illustrated in the first quadrant in FIG. 6. The slope of a line illustrated in the first quadrant is adjusted such that the maximum value 1023 of gradations of a 10-bit video signal matches with the maximum value Bmax of the gradation-display luminance converting characteristics and the minimum value 0 matches with the minimum value Bmin.

The input signal P is data-converted into drive data for a video light emitter (image displaying unit) such that light is emitted at the luminance B between the maximum value Bmax and the minimum value Bmin using conversion characteristics (predetermined conversion characteristics) illustrated in the second quadrant. The input signal P is subjected to a gradation-luminance conversion according to conversion characteristics illustrated in the second quadrant, thereby causing the video light emitter 107 to emit light at the luminance B.

The conversion characteristics illustrated in the second quadrant is a curve acquired by an experiment, which will be described later. This curve is a function that divides a difference of luminance between the maximum value Bmax and the minimum value Bmin of luminances at a pixel of the video light emitter 107 into differences in luminance in a sensorily even manner. The conversion characteristics illustrated in the second quadrant is that characteristics illustrated in FIG. 3 has been turned counterclockwise 90 degrees.

As illustrated in FIG. 3, as to the gradation-luminance converting characteristics, in an intermediate gradation range (303), the basis thereof is a proportional relation where the common logarithm of the luminance of the displaying substantially proportionally increases with respect to increase of the gradation. However, the variation quantity of the common logarithm of the luminance of the displaying assigned to an increment of gradation is increased in a high luminance and gradation range (304), in comparison with the intermediate gradation range (303), so as to compensate for reduction in ability of human eyes to discriminate variations in luminance in a high luminance range. The variation quantity of common logarithm of the luminance of the displaying assigned to an increment of gradation is increased also in a low luminance and gradation range (302), with respect to the intermediate gradation range (303), so as to compensate for reduction in ability of human eyes to discriminate variations in luminance in the low luminance range (302).

That is, on the maximum value side of the gradation, the relation gradually deviates from the proportional relation; the nearer the gradation approaches the maximum value, the larger a deviation quantity from the proportional relation between the gradation in the intermediate gradation range (303) and the common logarithm of the luminance of the displaying becomes. Further, on the minimum value side of the gradation, the relation gradually deviates from the proportional relation; the nearer the gradation approaches the minimum value, the larger a deviation quantity from the proportional relation between the gradation in the intermediate gradation range (303) and the common logarithm of the luminance of the displaying becomes.

The video light emitter 107 has its own light emitting system and light emitting characteristics. Accordingly, when the luminance signal 105 for actually emitting light at the luminance B is input, the light emission luminance controller 106, which exists for driving and controlling the video light emitter 107, controls the luminance signal 105 and the light emitting luminance B.

<Experiment>

A determination of light emitting luminance value from a video gradation signal, which characterizes the present invention, will be described. The visual characteristics in this example are luminance discriminability threshold characteristics with respect to the incident light luminance incident in the eyes.

An experiment is performed in a visual environment controlled to a certain luminance in a state where adaptation to the luminance is well secured. The incident light luminance incident in the eyes is successively changed from the minimum incident light luminance, which is not sufficiently perceivable, to the maximum incident luminance, which is glaring and imperceptible, and the luminance discriminability threshold contrast at each incident light luminance is measured. A method for measuring luminance discriminability threshold contrast in a certain visual environment light will be described.

(1) A light source capable of adjusting the light emitting quantity is used, and light emitted from the light source is separated into two beams.

(2) One of the beams of light having been separated into two is referred to as reference light I. The luminance value thereof (reference light luminance value) is controlled by light emitting quantity adjustment of the light source.

(3) On the other hand, a transparent filter (gradation ND filter) with continuously varying density is arranged in the optical path of the other one of the beams of light having separated into two, generating experimental light Iₜₑₛₜ.

(4) The reference light I and the experimental light Iₜₑₛₜ are incident in the pupil of a test subject in adjacent manner with no separation.

(5) The test subject slightly moves the position of the gradation ND filter and thereby changes the experimental light luminance value, and determines a luminance difference, when a luminance difference δI=I−Iₜₑₛₜ between the reference light and the experimental light adjacent to each other cannot be discerned, as a luminance difference discriminability threshold.

(6) Next, in order to acquire a luminance difference discriminability threshold of different reference light, the reference light luminance is changed and fixed by light emitting quantity adjustment of the light source.

(7) The above-described (5) and (6) are repeated and thereby the reference light luminance is changed from a low (dark) reference light luminance where the luminance difference is imperceptible even with the ND filter with sufficiently high density to a high (bright) reference light luminance where the luminance difference is imperceptible even with the ND filter with sufficiently low density, and the luminance difference discriminability thresholds corresponding thereto are acquired.

(8) Lastly, each luminance difference discriminability threshold value is divided by the reference luminance value to be normalized, thereby acquiring the luminance difference discriminability threshold contrast value C=δI/I.

FIG. 2 is a diagram illustrating luminance discriminability threshold contrast (Y axis) characteristics with respect to incident light luminances (X axis). As with DICOM-GSDF characteristics 305, when the incident light luminance is low (dark), the discriminability threshold contrast is large; the higher the incident Tight luminance, the smaller the discriminability threshold contrast becomes. However, when the incident light luminance further increased, the discriminability threshold contrast becomes larger again, in contrast to the DICOM-GSDF characteristics. This indicates appearance of a phenomenon that the sensitivity characteristics are reduced again in the high luminance range.

A range where sensitivity characteristics of luminance difference are high in view of common logarithm is a range where a difference in luminance substantially constant to increments of the common logarithm of the luminance is sensed. Gradations of constant differences in luminance can be secured by assigning the gradations at equal intervals. However, in a range where, the lower the luminance of an image, the lower the ability to discriminate the difference in luminance becomes, the “luminance difference in a common-logarithmic representation” should be assigned to the difference of gradation in a gradually increasing manner. Otherwise, the same difference in luminance as the range with the high sensitivity characteristics cannot be sensed with respect to the gradation with the same difference of gradation. Likewise, in a range where, the higher the luminance of the image, the lower the ability to discriminate the difference in luminance becomes, the “luminance difference in a common-logarithmic representation” should be assigned to the difference of gradation in a gradually increasing manner. Otherwise, the same difference in luminance as the range with the high sensitivity characteristics cannot be sensed with respect to the gradation with the same difference of gradation.

In this example, such visual characteristics are reflected, the gradation-display luminance converting characteristics illustrated in FIG. 5 are formed, and the gradation-display luminance converting characteristics are assigned to the entire gradations of the video signal as illustrated in FIG. 6.

<Gradation-Display Luminance Converting Characteristics>

FIG. 3 is a diagram plotting a solid line 301 in a coordinate axes illustrated in FIG. 22 based on FIG. 2, where the abscissa is the JND index and the ordinate is the stimulating light luminance. For the sake of reference and comparison, the GSDF characteristics 305 are illustrated on the figure. Procedures of converting FIG. 2 into FIG. 3 will hereinafter be described.

With respect to the data on each point on the curve in FIG. 2, the discriminable luminance threshold contrast (δI/I), which is the ordinate, is multiplied by the stimulating luminance (I), which is the abscissa, and thus FIG. 4, where the stimulating luminance (I) is specified as the abscissa and the discriminable luminance threshold (δI) is specified as the ordinate, is created.

Operation of Equation 6 is performed on the data of each point on the curve in FIG. 4, thereby acquiring sigmoid curve characteristics in FIG. 5.

$$\begin{matrix} [ Math . 6 ] & \\ {I}_{0} = minimum luminance value for ( j = 1 ; j \leq ( {1}_{j - 1} < maximum luminance value ) ; j ++ ) \times \{ \begin{matrix}JNDINDEX = j ; \\ {I}_{j} = {I}_{j - 1} + δ {I}_{j - 1} ;\end{matrix} \} & ( Equation 6 )\end{matrix}$$

An operational equation of Equation 6 will be described in a step-by-step manner.

Step 1: JND INDEX=0 and luminance=0.1 are plotted in FIG. 3, while the minimum luminance value (in this example, the minimum luminance value is 0.1 cd/m².) of stimulating luminance I in FIG. 4 is specified as the starting point.

Step 2: The starting point stimulating luminance I=0.1 cd/m² of step 1 is input into the stimulating luminance, which is the abscissa of FIG. 4, the discriminable luminance threshold 51 for the stimulating luminance 0.1 cd/m² is referred to, thereby acquiring the discriminable luminance threshold (SI). In this example, the discriminable luminance threshold of the stimulating luminance 0.1 cd/m² is 0.02.

Step 3: Since the discriminable luminance threshold for luminance I=0.1 cd/m² is δI=0.02 cd/m², the subsequently discriminable stimulating luminance I is 0.1+0.02=0.12 cd/m². Accordingly, JND INDEX=1 and luminance=0.12 cd/m² are plotted in FIG. 3.

Step 4: Returning to step 3, the discriminable luminance threshold δI is referred to from the stimulating luminance 0.12 cd/m² in FIG. 4, and the discriminable luminance threshold δI=0.03 is acquired. The discriminable luminance threshold for the stimulating luminance 0.12 cd/m² is specified as 0.03.

The discriminable luminance threshold δI=0.03 is added to the luminance=0.12 cd/m², as with step 3. The luminance discriminable subsequent to the stimulating luminance 0.12 cd/m² is 0.12+0.03=0.15 cd/m². Accordingly, JND INDEX=2 and the luminance=0.15 are plotted in FIG. 3.

Step 6: This step is repeated and the plotting is performed in FIG. 3 until the maximum luminance value of the stimulating luminance I of FIG. 4 or 2 is reached. In this example, the maximum luminance value is specified as 10000 cd/m².

In this example, FIG. 4 is firstly created for the sake of simplicity of description. However, if the discriminable luminance threshold contrast (δI/I) is multiplied by the stimulating luminance (I) and the discriminable luminance threshold (δI) is acquired every time in a necessary step, FIG. 3 can be created directly from FIG. 2.

Next, a qualitative concept of the JND index-stimulating light luminance characteristics created in the above steps will be described.

As illustrated in FIG. 3, in a case where the luminance difference calculated using the common logarithm that humans can discern a difference of luminances is specified as the discriminable luminance threshold, a plurality of gradations set between the maximum value and the minimum value of the gradations is set corresponding to the increment with even discriminability threshold degree.

Here, the range 302 indicates that the discriminable luminance threshold contrast of the stimulating light luminance (FIG. 2 abscissa) in FIG. 2 is large and the stimulating sensitivity is low in a range with low stimulating light luminances (ordinate of FIG. 3). Therefore, in order to acquire evenly separated perceived quantities in the range 302, the stimulating luminance variation should be increased. Accordingly, the stimulating light luminance changing quantity (the slope in the figure or the derivative value) for the JND index changing quantity is large.

It is represented that the discriminable luminance threshold contrast in FIG. 2 of the corresponding stimulating light luminance is decreased, and the stimulating sensitivity is increased from the range 302 to the range 303. Accordingly, the stimulating light luminance changing quantity (the slope in the figure or the derivative value) for the JND index changing quantity is decreased from the range 302 to the range 303.

Further, it is represented that the discriminable luminance threshold contrast in FIG. 2 is increased and the stimulating sensitivity is reduced again from the range 303 to the range 304. Corresponding to this, the stimulating light luminance changing quantity (the slope in the figure or the derivative value) for the JND index changing quantity is increased again from the range 303 to the range 304.

In order to thus increasing luminance from a sense of darkness to a sense of brightness while evenly changing the perceived quantity, the slope of the luminance of light incident in the eyes on the logarithmic axis should be changed such that from an decrease to an increase (slope quantity (derivative value) is large small→large).

Based on the visual characteristics related to human sense of luminance having been analyzed above, a method of creating the gradation-display luminance converting LUT will hereinafter be described.

The video light emitter 107 of the video display apparatus 101 may have various values as the light emitting luminances according to the light emitting system and the design specification. Here, the minimum light emitting luminance of the light emitting luminance (BRIGHTNESS) B of the video light emitter 107 is specified as Bmin, and the maximum light emitting luminance is specified as Bmax. FIG. 5 is a diagram where the name of abscissa is replaced with the input signal level P from that of FIG. 3 and the name of ordinate is replaced with the light emitting luminance B of the video light emitter 107 therefrom. The input signal level P corresponds to the JND index illustrated in FIG. 3, and represents a video signal having an even gradation in luminance sense.

The minimum light emitting luminance Bmin and the maximum light emitting luminance Bmax are converted into corresponding input signal levels Pmin and Pmax, respectively, by referring to FIG. 5. Accordingly, the maximum value of gradations is matched with the maximum luminance displayable on the video light emitter (image displaying unit) 107, and the entire gradations of the video signal 103 are linearly correlated within an extent of input signal levels Pmin to Pmax. In this example, the video signal 103 is a 10-bit signal from 0 to 1023. Accordingly, the following equation is held, where 0→Pmin, 1023→Pmax and the video signal value is S,

$$\begin{matrix}[ Math . 7 ] & \\ p = \frac{( {p}_{max} - {p}_{min} )}{1023} s + {p}_{min} & ( Equation 7 )\end{matrix}$$

This linear conversion is performed by an LUT of input of 1024 gradations and output (Pmax-Pmin). The gradation/light emission luminance converter 104 includes two converting tables, which are the above-described video signal-input signal level P converting LUT and the input signal level P-light emitting luminance converting LUT illustrated in FIG. 5. The video signal 103 is converted into the input signal P by the video signal S-input signal level P converting LUT illustrated in the first quadrant in FIG. 6. Subsequently, the input signal P is converted into data corresponding to the luminance B with characteristics illustrated in the second quadrant in FIG. 6, thereby causing the video light emitter 107 to emit light with the luminance B.

As described above, in Example 1, the gradations without discontinuity/crush/saturation in perception can be reproduced over the entire light emitting luminance range (dynamic range) of the video display apparatus 101. The image display apparatus capable of outputting a video having light emitting luminance characteristics according to human visual characteristics can be provided. The gradation properties of the video signal and the luminance sense match with each other even for any receiving luminance quantity in the visual dynamic range. Senses of skip and crush do not occur even when any video signal is displayed. Thus, a smooth gradation video can be viewed.

The video signal processing unit 104 may perform gradation conversion processing, using DSP (digital signal processor) internally including a RAM. This processing reads gradation values of the respective pixels from the video signal transmitted as a serial data, and corrects the values into gradation values where the gradation-display luminance converting characteristics are reflected.

An image processing may be performed such that the image data of the input image formed in various formats is reproduced as the gradation data for the respective pixels, and converted into gradations where the gradation-display luminance converting characteristics of this example are reflected, thereby acquiring one image data. In this case, the gradation/light emission luminance converter 104 can be operated as one image processing apparatus independent from the video light emitter 107.

### Example 2

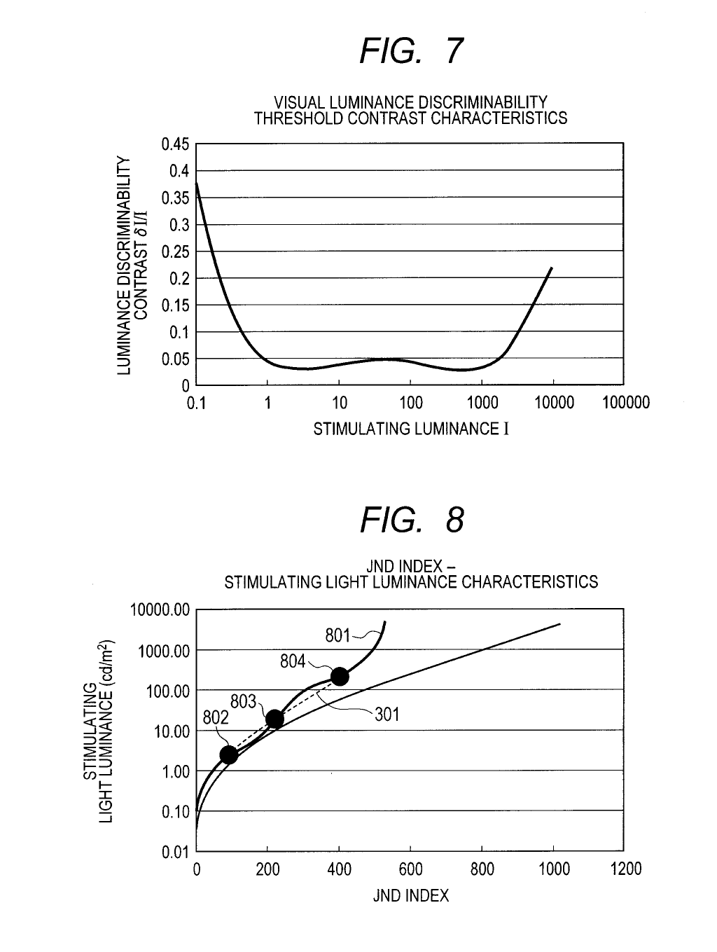

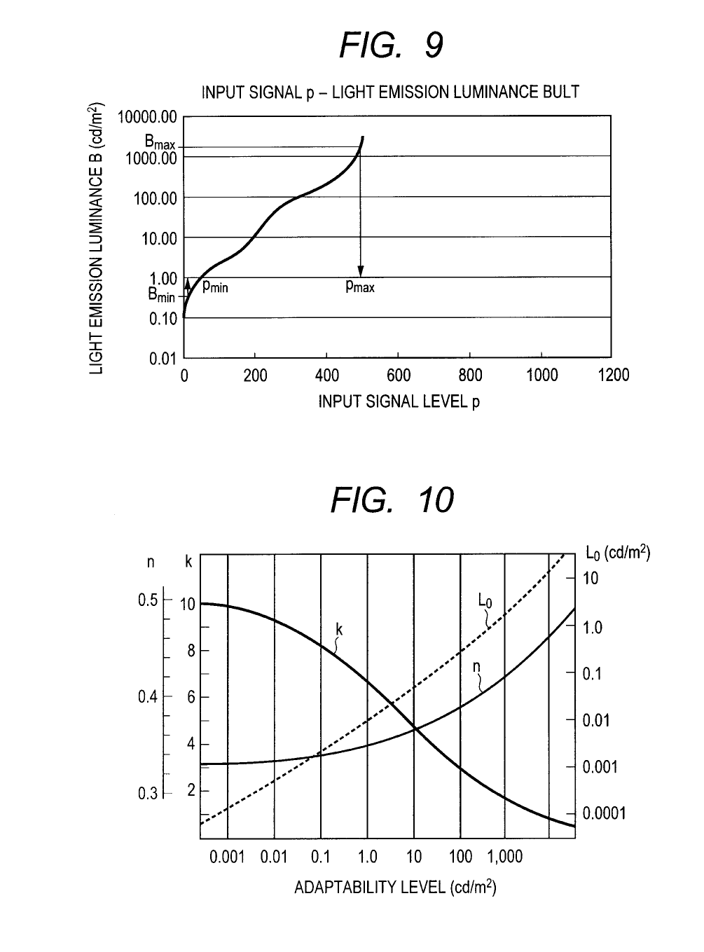

FIG. 7 is a diagram of luminance discriminability threshold contrast characteristics with respect to incident light luminances in Example 2. FIG. 8 is a diagram of visual stimulating light luminance characteristics with respect to JND index in Example 2. FIG. 9 is a diagram of light emitting luminance characteristics with respect to input signal levels in Example 2.

Example 2 is configured and controlled in the same manner as Example 1 except for that characteristics of the gradation-display luminance converting LUT implemented in the gradation/light emission luminance converter 104 of the video display apparatus 101 are different from those of Example 1. Accordingly, a difference with Example 1 in the characteristics of the gradation-display luminance converting LUT will hereinafter be described, and the other redundant description will be omitted.

FIG. 7 is a diagram representing luminance discriminability threshold contrast characteristics with respect to incident light luminances and corresponds to FIG. 2 in Example 1. As a result of the above-described experiment, it has been found that the characteristics become such that the bottom of the curve is flat as in FIG. 2 when the room is illuminated but the characteristics become such that the bottom of the curve is bulgy as in FIG. 7 when the room is in low light. It is found that decrease, increase, decrease and increase having a slight local maximum value and two local minimum values appear corresponding to increase in incident light luminance value as illustrated in FIG. 7 according to luminance in the environment where humans watch the video display apparatus 101. Further, it has been found that the luminance in a room where the characteristics as illustrated in FIG. 7 appear to vary according to the test subject.

Thus, Example 2 includes an illuminance sensor (ambient light measuring unit) 108 for detecting ambient luminance is provided as illustrated in FIG. 1, and employs control that switches to the gradation-display luminance converting LUT based on the characteristics of FIG. 7 when the luminance in the room is, for example, less than or equal to one lux. The gradation/light emission luminance converter (gradation converter) 104 converts the image data such that the common logarithm of the changing quantity of luminance assigned to a gradation increment is locally increased in a middle part between a range approaching the maximum value of gradations and a range approaching the minimum value of gradations. The gradation/light emission luminance converter (gradation converter) 104 locally reduces the increment in a range where the common logarithm of the changing quantity of luminance increases when the ambient luminance exceeds a certain luminance.

The visual feature illustrated in FIG. 7 changes basically as with the visual feature of FIG. 2. When the incident light luminance is the lowest (dark), the discriminability threshold contrast is large. The higher the incident light luminance, the lower the luminance discriminability threshold contrast becomes. On the other hand, when the incident light luminance is the highest (bright), the luminance discriminability threshold contrast is large. The lower the incident light luminance, the smaller the luminance discriminability threshold contrast becomes. Note that the curve includes decrease, increase, decrease and increase having the slight local maximum value and two local minimum values according to increase of the incident light luminance value. On the other hand, the visual feature illustrated in FIG. 2 is the curve of decrease and increase where the luminance discriminability threshold contrast has one local minimum value according to increase of the incident light luminance value.

Such visual characteristics were converted by the operational equation, Equation 6, according to FIG. 3 of Example 1, thereby creating FIG. 8. FIG. 8 illustrates JND index-stimulating light luminance characteristics 801 where the JND index is plotted as the abscissa and the stimulating light luminance is plotted as the ordinate. In this figure, a narrow broken line 301 represents conversion characteristics of Example 1 illustrated in FIG. 3; a narrow broken line 305 represents GSDF characteristics.

As illustrated in FIG. 8, the JND index-stimulating light luminance characteristics 801 has three inflection points 802, 803 and 804 and increases corresponding to the luminance discriminability threshold contrast characteristics with respect to the incident light luminance in FIG. 7.

In view of such characteristics, steps of creating the LUT as with Example 1 are performed, thereby creating a gradation-display luminance converting LUT illustrated in FIG. 9. However, the step of creating FIG. 4 described in Example 1 is omitted. FIGS. 2 and 3 are replaced with FIGS. 7 and 8, respectively. Numeric data used for, the operation is replaced with numeric values corresponding to the respective diagrams.

FIG. 9 illustrates an input signal level-light emitting luminance LUT implemented in the gradation/light emission luminance converter 104 of the video display apparatus 101. Also in the input signal level-light emitting luminance characteristics in FIG. 9, as with the Example 1, when the incident light luminance is increased from the sense of darkness with the lowest light so as to increase the sense of luminance, the incident light luminance forms a curve where the change of slope is decreased in the common logarithm axis and the curve is upwardly convex. In a range of the brightest sense of luminance after the plurality of inflection points, the change of the slope of the incident light luminance is increased in the logarithmic axis and forms a downwardly convex curve.

As described above, in Example 2, the gradations without discontinuity/crush/saturation in perception can be reproduced over the entire light emitting luminance range (dynamic range) of the video display apparatus 101. The image display apparatus capable of outputting a video having light emitting luminance characteristics according to human visual characteristics can be provided.

<Common Logarithm>

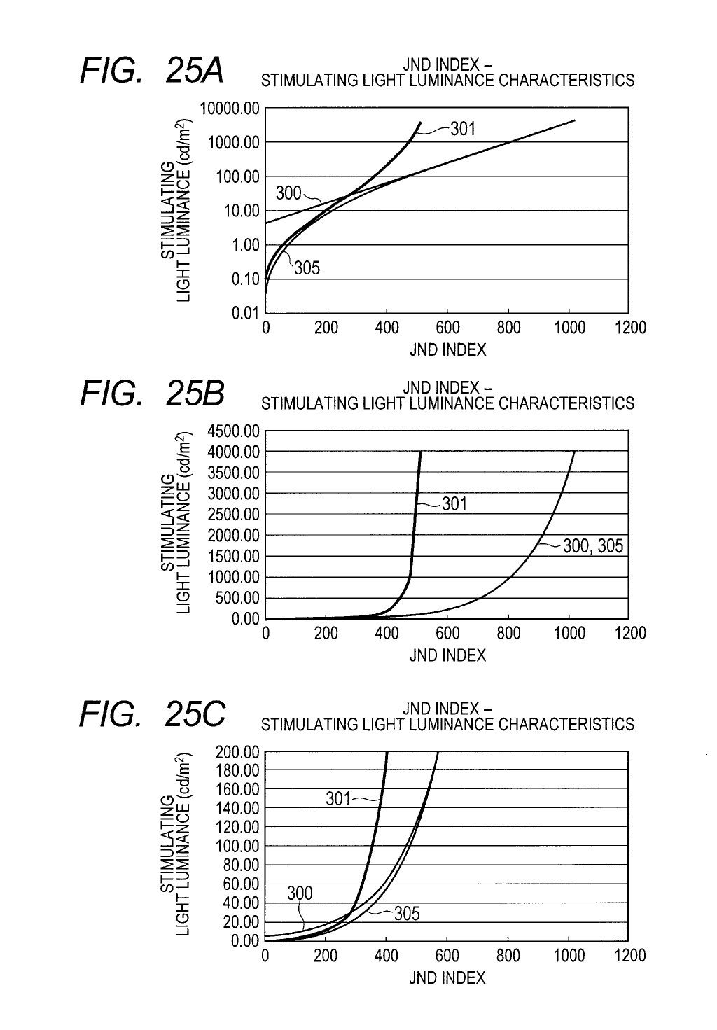

FIGS. 25A, 25B and 25C are diagrams illustrating a reason for using common logarithms.

FIGS. 25B and 25C are diagrams where the ordinate of the gradation-display luminance converting characteristics (301) of Example 1 illustrated in FIG. 25A is represented in real numbers. FIG. 25C is a diagram where FIG. 25B is partially enlarged. Each diagram illustrates the Weber-Fechner linear equation (300) and GSDF characteristics of DICOM (305) based thereon.

In the real number axis representations illustrated in FIGS. 25B and 25C, it is difficult to discriminate three functions from each other. In contrast to FIG. 25A, three types of conversion characteristics cannot be intuitively discriminated from each other. As recited in NPL 1, according to evaluation of the luminance of the displaying using the common logarithm, a proportional relation between the common logarithm of the luminance of the displaying and the increments of the luminance sense appear in the intermediate gradation range.

However, after differences between the three functions are recognized theoretically and experimentally, it is easy to create an approximate expression in a real number axis representation, and to operate gradation-display luminance converting characteristics (301) of Example 1. The image display apparatus may use gradation-display luminance converting characteristics assigning the real number value of the luminance of the displaying to the gradation value. Gradation-display luminance converting characteristics having an effect similar to that of Example 1 may be created based on another operational equation by a curve y=xn (n=0.3) representing visual characteristics analogous to the common logarithm.

Accordingly, the present invention is not limited to examples that create the gradation-display luminance converting LUT through the operation using the common logarithm. Instead, the present invention includes a conversion processing using a gradation-display luminance converting LUT acquired using another operational equation and real number values. The operation may be replaced with any one of a data conversion using a data table, an interpolation operation of at least two functions, and an operation using one of an approximate expression and a function similar to the common logarithm. In any case, the present invention includes examples capable of acquiring gradation-display luminance converting characteristics similar to those using conversing equation created through an operation using the common logarithm.

### Embodiment 2

Embodiment 2 of the present invention will be described in detail with reference to drawings. The present invention can be applicable to another embodiment where a part or the entire configuration of Embodiment 2 is replaced with an alternative configuration thereof, only if the higher the ambient luminance, the smaller the deviation from the GSDF characteristics around the maximum value of gradations becomes.

In this Embodiment 2, a video display apparatus only having a displaying function such as a computer display will be described as an image display apparatus. However, a television receiver and electronic viewfinders mounted on a camera and a video camera, which are video display apparatuses including a video and audio receiving unit, also referred to as video display apparatuses. The video display apparatus can be used for an image display apparatus, such as a CRT, a liquid crystal display, a plasma display and an organic EL display.

With respect to the general matters related to the configuration and control of the image display apparatus disclosed in the conventional art, illustration thereof in drawings is omitted and redundant description is also omitted.

<Conventional Art>

A video display apparatus is used in variously changing environmental light. Accordingly, with fixed adjustment of image quality, the image quality deteriorates owing to an influence of the environmental light. For example, in consideration of the visual environment in a home, the visual environment illuminance is very different between a case where curtains are opened in the daytime of a bright day and a case of viewing a movie in low light.

According to fixed adjustment of the image quality that adjusts the image so as to acquire the finest image in a certain average visual environment illuminance, the displayed video is sensed too dark in the daytime, but sensed too bright in the nighttime. It can be said that the image quality deteriorates according to the environmental light illuminance. In order to alleviate such deterioration of image quality, it has been proposed that the video display apparatus is provided with an illuminance sensor for measuring an environmental light intensity, adjusts the gain of a video signal according to the ambient environmental illuminance in viewing and thereby maintains the image quality. This technique has been realized.

PTL 1 has proposed a method that acquires a function of calculating a subjective scale value with a parameters of a luminance, a contrast and gradation characteristics and thereby adjusts the image quality so as to satisfy the subjective scale value. With respect to a relation between the environmental light illuminance and the image quality adjustment, a contrast in a bright place is calculated by measuring an environmental light illuminance, and used as a parameter for adjusting the image quality.

PTL 2, in order to address change in environmental light, a liquid crystal panel is arranged as a displaying unit, and the transmittance is changed according to the intensity of environmental light. In this case, the gradation characteristics of a video signal are fixed so as to avoid decrease in gradation in a case where the luminance is adjusted by modifying the gain of the gradation characteristics.

PTL 3 performs a contrast correction, a gamma correction and a contour correction according to levels of an average luminance of a video signal, a dynamic range and environmental light, and thereby adjust the image quality according to change of the video signal and the environmental light.

Although PTL 1 uses the contrast in a bright place, the contrast in a bright place is represented by the contrast in a place with low light and the environmental light illuminance, and the contrast in a place with low light is a value dependent on the display apparatus. Thus, human visual characteristics owing to the environmental light illuminance are not considered. However, the subjective scale value is calculated based on a subjective evaluation. Accordingly, the visual characteristics may implicitly be included. However, visual characteristics based on adaptation to the environment light are not considered.

PTL 2 changes the luminance of a displaying unit according to an environmental light illuminance. However, the gradation characteristics of a video signal are still fixed. Human visual characteristics change according to a state of adaptation to the environmental light. Accordingly, the gradation characteristics also change. Therefore, with the fixed gradation characteristics, the best gradation characteristics according to the visual characteristics cannot be acquired. There has been a possibility of causing malfunctions, such as skip and crush, in reproduction of gradations.

PTL 3 performs a contrast correction, a bright correction, a gamma correction and a contour correction according to an average luminance, a white peak, a black peak and noises, and environmental light. Here, with respect to the gamma correction related to gradation characteristics, it is described to perform a method of conversion according to data stored on a ROM and conversion according to a nonlinear element. However, any specific method of calculating gradation characteristics is not described. Further, change of human visual characteristics with respect to the environmental light is not described.

In the following example, in consideration of change of human visual characteristics according to adaptation in the luminance environment on viewing of a display apparatus, a method of calculating light emitting luminance characteristics of the display apparatus according to the environmental light has been proposed. Further, conversion is made based on calculated light emitting luminance characteristics, thereby reproducing visually smooth and optimal gradations.

According to this, the gradations without discontinuity/crush/saturation in perception can be reproduced over the entire light emitting luminance range (dynamic range) of the video display apparatus, even in various types of environmental light.

The following example represents a relation between an incident luminance in a plurality of adapting luminances and the luminance difference discriminability threshold contrast as a polynomial that transitions from monotonic decrease to monotonic increase via a local minimum value according to transition of the incident luminance from a low luminance to a high luminance. This polynomial represents characteristics that, the higher the adapting luminance, the narrower the intersection distance with a specific luminance difference discriminability threshold contrast becomes and the higher the incident luminance at the position of the local minimum value becomes. Further, luminance difference discriminability threshold characteristics corresponding to the adapting luminance is calculated using the polynomial. The light emitting luminance is assigned such that the luminance difference discriminability threshold becomes one gradation, thereby determining the light emitting luminance characteristics.

According to this, even with an unknown adapting luminance on which no experiment has been performed, light emitting luminance characteristics (gradation-display intensity converting characteristics) only with a slight error can be acquired.

### Example 3

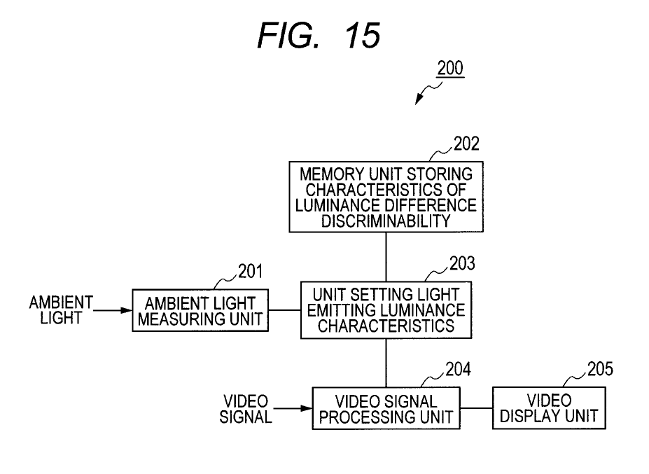

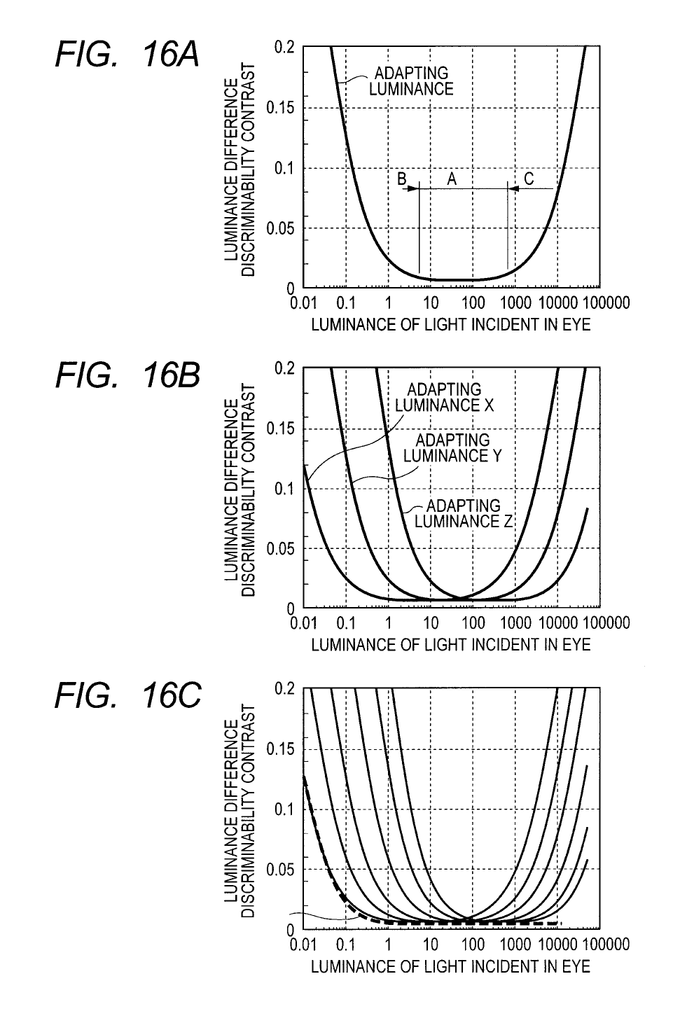

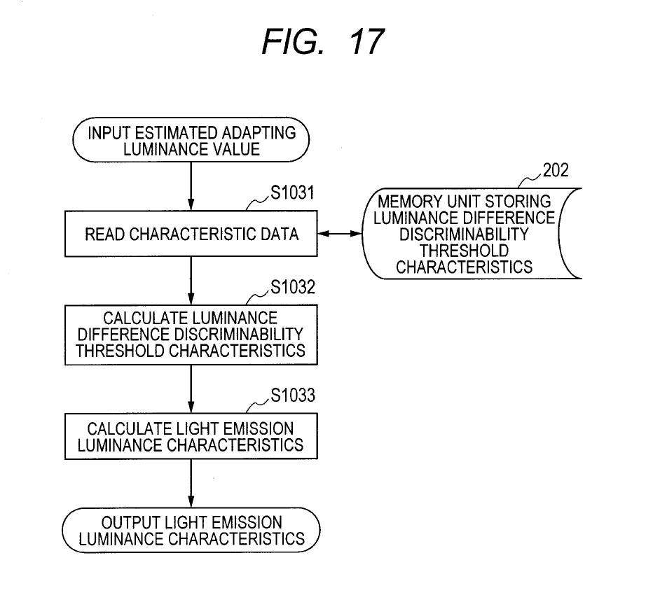

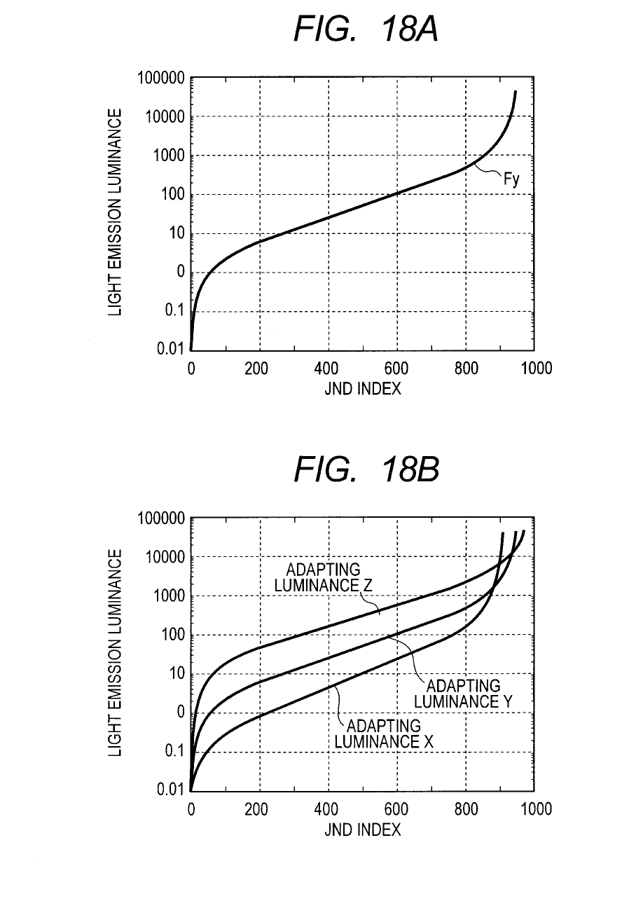

FIG. 15 is a block diagram illustrating a configuration of a video display apparatus according to Example 3. FIGS. 16A to 16C is a schematic diagram illustrating a relation between luminances of light incident in the eyes and luminance difference discriminability threshold contrast. FIG. 17 is a flowchart illustrating of an operation of a unit setting light emitting luminance characteristics according to Example 3. FIG. 18 is a schematic diagram illustrating light emitting luminance characteristics. FIGS. 4 to 6 are diagrams illustrating light emitting luminance characteristics that convert gradations of an image into luminances of the displaying. FIG. 9 is a diagram of visual stimulating light luminance characteristics with respect to JND index.

As shown in FIG. 15, a video display apparatus 200 is an image display apparatus that receives a video signal from a computer and displays the image on a screen of an image displaying unit in a luminance representation. An ambient light measuring unit 201 is a luminance sensor that measure visual environmental light around the video display apparatus 200. A memory unit storing characteristics of luminance difference discriminability threshold 202 stores luminance difference discriminability threshold characteristics at various adapting luminances. A video light emitter 207 includes one of a liquid crystal display panel and a plasma panel. The value of luminance of the displaying is linearly changed according to a luminance signal 205.

A unit setting light emitting luminance characteristics 203 calculates light emitting luminance characteristics from luminance difference discriminability threshold characteristics in a luminance environment around the video display apparatus 200. A video signal processing unit 204 performs processing of gradation characteristics and processing of another video signal, using light emitting luminance characteristics set by the unit setting light emitting luminance characteristics 203, and outputs the result to the video display unit 205.

As illustrated in FIG. 6, light emitting luminance characteristics Fy is characteristics for assigning luminance steps of the video display unit 205, where each gradation of a 10-bit and 1024-step video signal S has been converted into a common logarithm. The light emitting luminance characteristics Fy are conversion characteristics of the gradation-display luminance where the luminance sense for each increment of gradations of an image changes at equal intervals between the maximum luminance Bₘₐₓ and the minimum luminance Bₘᵢₙ displayable on the video display unit 205 in a predetermined luminance environment.

In an intermediate gradation range, the basis of the light emitting luminance characteristics Fy is a proportional relation that the common logarithm of the luminance of the displaying increases proportionally to increase of the gradation compliant with the above-mentioned GSDF characteristics. In the high luminance and gradation range, the variation quantity of the common logarithm of the luminance of the displaying assigned to an increment of the gradation is increased in comparison with the intermediate gradation range so as to compensate for reduction in ability of human eyes to discriminate differences in luminance in the high luminance range. Further, in the low luminance and gradation range, a variation quantity of the common logarithm of the luminance of the displaying assigned to an increment of the gradation is increased in comparison with the intermediate gradation range so as to compensate for reduction in ability of human eyes to discriminate differences in luminance in the low luminance range.

As to light emitting luminance characteristics Fy, on the maximum value side of the gradation, the relation gradually deviates from the proportional relation between the gradation in the intermediate gradation range and the common logarithm of the luminance of the displaying. The nearer the gradation approaches the maximum value, the larger the deviation quantity becomes. Further, on the minimum value side of the gradation, the relation gradually deviates from the proportional relation between the gradation in the intermediate gradation range and the common logarithm of the luminance of the displaying. The nearer the gradation approaches the minimum value, the larger the deviation quantity becomes.

The light emitting luminance characteristics are changed according to the ambient luminance detected by the ambient light measuring unit 201. As to the light emitting luminance characteristics Fz applied to a bright environment, an increment of the variation quantity of the common logarithm of the luminance of the displaying (deviation quantity from a proportional relation in the intermediate gradation range) in the high luminance and gradation range is smaller than that of the light emitting luminance characteristics Fy. The gradation range of the light emitting luminance characteristics Fz deviating from the proportional relation on the high luminance gradation side is narrower (disappeared) than that of the light emitting luminance characteristics Fy.

On the other hand, as to the light emitting luminance characteristics Fx applied to the environment with low light, an increment of the variation quantity of the common logarithm of the luminance of the displaying (deviation quantity from a proportional relation in the intermediate gradation range) in the high luminance and gradation range is larger than that of the light emitting luminance characteristics Fy. The gradation range of the light emitting luminance characteristics Fx deviating from the proportional relation on the high luminance gradation side is wider than that of the light emitting luminance characteristics Fy.

Thus, the gradation-display luminance converting characteristics of the high luminance and gradation range is determined, and differences in luminance at equal intervals of gradations in the intermediate gradation range and the high luminance and gradation range are provided. As a result, the higher the ambient luminance, the higher the luminance of the entire image becomes. Therefore, a sense of equal intervals of the difference in luminance of gradations in the intermediate gradation range and the high luminance and gradation range is dramatically increased in comparison with a case of simply changing the luminance of the entire image according to the ambient luminance.

<Light Emitting Luminance Characteristics>

The light emitting luminance characteristics Fy can be acquired by measuring luminance difference discriminability threshold characteristics, which are luminance characteristics of the luminance difference that humans can discriminate the difference in luminance, through an experiment, and calculating based on the result of measurement thereof. As illustrated in FIG. 16A, the luminance difference discriminability threshold characteristics represents how the human ability to discriminate the difference in luminance changes according to the luminance of the image (luminance of light incident in the eyes).

As to a method of experiment, a test subject is firstly adapted to a certain luminance in a room. In a state of adaptation, reference light and experimental light with a luminance different from the reference light are projected to the test subject. It is investigated whether the test subject can discriminate the luminance difference between the reference light and the experimental light or not. In this case, the reference light is fixed, the luminance of the experimental light is slightly changed, and the luminance where the test subject cannot discriminate the luminance difference is acquired as the luminance difference discriminability threshold. Next, in order to acquire the luminance difference discriminability threshold for a different reference light, the reference light luminance is changed and fixed. The experimental light luminance is analogously changed and the luminance difference discriminability threshold is acquired. This operation is repeated, and thereby the luminance difference discriminability threshold for a plurality of reference light luminances in an adaptation state in a certain luminance in the room can be acquired.

More specifically, the experiment has been performed in the following procedures.

(1) The test subject is adapted to a certain incident luminance (luminance of light incident in the eyes) that is visually sensed.

(2) Light emitted from a light source is separated into two beams using the light source capable of adjusting a light emitting quantity.

(3) One of the beams of light having been separated into two is referred to as reference light. The luminance value thereof (reference light luminance value) is controlled by light emitting quantity adjustment of the light source.

(4) On the other hand, a transparent filter (gradation ND filter) with continuously varying density is arranged in the optical path of the other one of the beams of light having separated into two, generating experimental light.

(5) The reference light and the experimental light are incident onto the pupil of a test subject in adjacent manner with no separation.

(6) The test subject slightly moves the position of the gradation ND filter and thereby changes the experimental light luminance value, and determines a luminance, when a luminance difference between the reference light and the experimental light adjacent to each other cannot be discriminated, as a luminance difference discriminability threshold.

(7) Next, in order to acquire a luminance difference discriminability threshold of different reference light, the reference light luminance is changed and fixed by light emitting quantity adjustment of the light source.

(8) The (6) and (7) are repeated, thereby acquiring luminance difference discriminability thresholds.

(9) Lastly, each luminance difference discriminability threshold value is divided by the reference luminance value to be normalized, thereby acquiring the luminance difference discriminability threshold contrast value.

As a result, as illustrated in FIG. 16A, visual characteristics where the ability to discriminate the differences in luminance is high in the background luminance of the screen 10-1000 cd/m² and the ability to discriminate the differences in luminance is gradually reduced at the outside thereof.

Next, the same test subject is adapted to another luminance in the room (luminance of light incident in the eyes), and a similar experiment is performed. Even with the same reference light luminance, the luminance difference discriminability threshold has a different value according to a state of adaptation. Accordingly, it is required to perform similar experiments in states of adaptation in various luminance environments (luminance of light incident in the eyes).

Thus, the relation between the reference light luminance and the luminance difference discriminability threshold in the states of adaptation to various luminances in the room can be acquired. This is specified as the luminance difference discriminability threshold characteristics.

It has been found that adapting luminance changes the difference in luminance on the screen according to the above experiment, as illustrated in FIG. 16B. That is, in the adapting luminance X with low light, the ability to discriminate the differences in luminance of the image is high until the luminance of the image becomes significantly low. On the high luminance side, the luminance of the image where the ability to discriminate differences in luminance is lowered is reduced. On the other hand, in the bright adapting luminance Z, the ability to discriminate the differences in luminance of the image is high until the luminance of the image is significantly increased. However, on the low luminance side, the luminance of the image where the ability to discriminate the differences in luminance is lowered is increased.

A luminance range A in luminance difference discriminability threshold characteristics illustrated in FIG. 16A is a range where a certain difference in luminance is sensed with respect to an increment of the common logarithm of the luminance. Accordingly, gradations are assigned at equal intervals, thereby allowing a gradation with a certain difference in luminance to be secured. In a luminance range B, the lower the luminance of the image, the lower the ability to discriminate the differences in luminance becomes. Accordingly, if a larger “luminance difference in a common-logarithmic representation” is not assigned to the difference of gradation, the increment of the difference in luminance as with the range A cannot be sensed. In a luminance range C, the higher the luminance of the image, the lower the ability to discriminate the differences in luminance becomes. Accordingly, if a larger “luminance difference in a common-logarithmic representation” is not assigned to the difference of gradation, the increment of the difference in luminance as with the range A cannot be sensed.

In Example 3, such visual characteristics are reflected, gradation-luminance of the displaying characteristics Fy illustrated in FIG. 18A are formed, and the gradation-luminance of the displaying characteristics Fy are assigned to the entire gradations of the image as illustrated in FIG. 6.

As to the luminance difference discriminability threshold characteristics in adapting luminances X, Y and Z illustrated in FIG. 16B, the higher the ambient luminance, the narrower the range where the luminance difference discriminability threshold characteristics are maintained to be a certain value becomes. That is, a range where the same variation quantity of the common logarithm of the luminance is assigned to gradations and the gradation-luminance of the displaying characteristics have a proportional relation is narrowed.

In Example 3, such visual characteristics are reflected, conversion processing is performed such that, the brighter the detected ambient light is, the larger a range where a deviation from the proportional relation becomes in the entire gradation range.

<Ambient Light Measuring Unit>

The ambient light measuring unit 201 includes a sensor measuring an illuminance arranged adjacent to the displaying unit of the video display apparatus 200, and measures the illuminance of the visual environmental light. In this case, an error correction circuit by means of a display video signal may be provided so as to alleviate miscalculation of environmental light, which is caused because the light emitted from the video display apparatus 200 is reflected at the peripheral object to become incident on the sensor.

A reaction of adaptation of a human occurs with respect to the luminance incident in the eyes. Accordingly, it is required to estimate the luminance incident in the eyes from a measured illuminance. For example, provided that the situation is equivalent to that of watching a reflection plate with a reflectivity p evenly diffusing by the measured illuminance E, the luminance L is represented by the following equation, which is referred to as adapting luminance.

$$\begin{matrix}[ Math . 8 ] & \\ L = \frac{ρ E}{π} & \end{matrix}$$

Here, when the environmental light illuminance is extremely low, a viewer carefully watches the video display apparatus even with a low environmental light illuminance. Accordingly, it can be considered that adaptation is attained to the luminance of the displayed image instead of adaptation to the environmental light illuminance. Thus, when the environmental light illuminance is extremely low, the luminance of displayed image should be considered. In this case, provided that the average of luminances of the displayed image is L_{DISP}, the corrected adapting luminance will be represented by the following expression.

$$\begin{matrix}[ Math . 9 ] & \\ L = \frac{ρ E}{π} + {L}_{DISP} & \end{matrix}$$

Further, in order to acquire the adapting luminance more accurately, the luminance sensor may be internally included as a remote controller, which is considered to be always disposed at a position near the viewer.

<Luminance Difference Discriminability Threshold Characteristics Storing Unit>

The luminance difference discriminability threshold characteristics storing unit 202 illustrated in FIG. 15 stores luminance difference discriminability threshold characteristics measured in various luminances in the room as illustrated in FIG. 16B.

A method of storing the data of the luminance difference discriminability threshold characteristics acquired by the above-mentioned experiment will be described. First, as represented by the following equation, a luminance of light incident in the eyes L_{IN} and a luminance difference discriminability threshold L_{D} are specified, and the luminance difference discriminability threshold is divided by the corresponding luminance of light incident in the eyes and a luminance difference discriminability threshold contrast C_{LD} is thereby specified.

$$\begin{matrix}[ Math . 10 ] & \\ {C}_{LD} = \frac{{L}_{D}}{{L}_{IN}} & \end{matrix}$$

According to the experiment by the inventors, the relation between the luminance of light incident in the eyes and the luminance difference discriminability threshold contrast are plotted and a curve is applied, thereby acquiring what is as with FIG. 16A. The schematic shape of this curve is a function that has a local minimum value and downwardly convex. In this figure, one local minimum value is represented. However, the number of local minimum values is not limited to one. Here, the luminance of light incident in the eyes is represented in common logarithm.

FIG. 16B illustrates a relation between the luminance of light incident in the eyes adapted to various luminance environments and the luminance difference discriminability threshold contrast. In this figure, an adapting luminance X is visual environmental light with low light. The nearer the environment approaches an adapting luminance Z, the higher the luminance in the environment becomes. As will be understood in comparison between curves in this figure, the minimum value and the position thereof and further manners of expansion of the curves are regularly changed according to a state of adaptation. This is represented by an approximation of a quartic function.

[Math. 11]

C_{LD}=A[log₁₀(L_{IN})−log₁₀(B)]⁴+C

In this figure, A is a coefficient determining the manner of expansion of the curve, B is a value of a luminance of light incident in the eyes corresponding to the minimum value of the curve, and C is a value of a luminance difference discriminability threshold contrast corresponding to the minimum value. These three values are changed according to the luminance of the environment.

Here, provided that the experiments are performed on n states of adaptation, fitting is performed by Equation 4 for the states of adaptation and thereby values are calculated in a manner where Aₙ is calculated from A₁, Bₙ is calculated from B₁ and Cₙ is calculated from C₁. Further, the fitting is performed on these coefficients by the respective adapting luminance values, thereby allowing the coefficients A, B and C to be represented as a function.

The characteristics of the coefficients A, B and C and an example of a function representing these will hereinafter be described.

The coefficient A becomes a value that, the higher the luminance of the adaptation environment light, the narrower the expansion of the curve representing the luminance difference discriminability threshold characteristics becomes. Accordingly, as illustrated in Equation 5, a coefficient Aₘ in a certain adaptation environmental light Lₘ is represented by an approximation of a linear expression for the adaptation environmental light, where the coefficients are α and β.

[Math. 12]

Aₘ=α₄ log₁₀(Lₘ)+β_{A}

The coefficients B and C represent the value of the luminance of light incident in the eyes representing the minimum value of the curve representing luminance difference discriminability threshold characteristics in each state of adaptation, and the value of the luminance difference discriminability threshold contrast. The coefficients B and C forms an envelope connecting the local minimum values as illustrated in FIG. 16C. The higher the luminance of the adaptation environmental light becomes, the farther the minimum value of the curve representing the luminance difference discriminability threshold characteristics moves to a direction with a higher luminance of light incident in the eyes. Accordingly, the higher the luminance of the adaptation environmental light becomes, the farther the coefficient B moves rightwardly on the envelope in FIG. 16C. When the envelope monotonically decreases as with FIG. 16C, the coefficient C moves to a direction with lower value of the luminance difference discriminability threshold contrast. Accordingly, the coefficients Bₘ and Cₘ in the certain adaptation environmental light Lₘ are represented by approximations of the following equations.

[Math. 13]

Bₘ=α_{B} log₁₀(Lₘ)+β_{B}

Cₘ=α_{C} log₁₀(Lₘ)+β_{C}

When the envelop becomes a quadratic curve, the coefficient Cₘ can be represented by an approximation by the following equation.

[Math. 14]

Cₘ=α_{C}[log₁₀(Lₘ)−log₁₀(β_{C})]²+γ_{C}

As described above, the luminance difference discriminability threshold characteristics storing unit 202 further performs fitting, using a function for the adaptation environmental light, on the coefficients having been acquired by fitting the luminance difference discriminability threshold characteristics using the function, and stores the coefficients. This enables the luminance difference discriminability threshold characteristics to be estimated accurately and easily in an adaptation environmental light on which an experiment has not been performed yet.

In Example 3, the luminance difference discriminability threshold characteristics are represented by Equation 4. However, in a case where more accurate luminance difference discriminability threshold characteristics is required to be used, fitting using a more complicated polynomial may be performed and change of the coefficients with respect to the adaptation environmental light may be stored as a function.

<Unit Setting Light Emitting Luminance Characteristics>

The unit setting light emitting luminance characteristics 203 calculates the light emitting luminance characteristics, using the coefficients A, B and C of the function representing the luminance difference discriminability threshold characteristics stored in the luminance difference discriminability threshold characteristics storing unit 202 and the estimated adapting luminance value acquired by the ambient light measuring unit 201.

An operation of the unit setting light emitting luminance characteristics 203 will hereinafter be described in detail using a flowchart of FIG. 17.

As illustrated in FIG. 17 with reference to FIG. 15, in step S1031, when the estimated adapting luminance value acquired by the ambient light measuring unit 201 is input, the luminance difference discriminability threshold characteristics is read from the luminance difference discriminability threshold characteristics storing unit 202. The data to be read here is the data of coefficients of the function for calculating the coefficients A, B and C of the curve representing the luminance difference discriminability threshold characteristics represented by the above-described Equations 5 and 6.

In step S1032, the coefficients Aₓ, Bₓ and Cₓ are calculated using Equations 5 and 6 from the coefficients read in step S1031. Accordingly, a relational expression representing between the luminance of light incident in the eyes L_{IN} at the adapting luminance estimation value L_{X} represented by Equation 4 and the luminance difference discriminability threshold contrast C_{LD} is acquired.

In step S1033, the light emitting luminance characteristics are calculated using the relational expression acquired in step S1032. The light emitting luminance characteristics are calculated according to the same method as the GSDF characteristics of DICOM (grayscale standard display function) disclosed in NPL 1. This method regards a unit of the minimum luminance difference perceivable by humans in a certain incident luminance as one JND (discriminability threshold), specifies this unit as one gradation, and calculates a relation between the necessary number of gradations of a video signal and the light emitting luminance.

Only with Equation 4, the luminance difference discriminability threshold contrast is calculated. Accordingly, the calculated result is then multiplied by the incident luminance value, thereby acquiring the curve of luminance difference discriminability threshold illustrated in FIG. 6.

Further, a certain incident luminance is specified as an initial value and plotted as a value of unit 0 of JNDINDEX in FIG. 5. It is appropriate to use the lowest light emitting luminance that the display apparatus can output as the initial value. The incident luminance is specified as the starting point. The luminance difference discriminability threshold illustrated in FIG. 4 is read. The incident luminance value that is shifted therefrom to the high luminance direction by the luminance difference discriminability threshold is read. This value is plotted in FIG. 5 as the value of unit one of JNDINDEX.

Next, the incident luminance value that is shifted from the incident luminance value for the unit one of JNDINDEX to the high luminance direction by the luminance difference discriminability threshold is read, and plotted in FIG. 5 as a value of unit two of JNDINDEX. Calculations that repeat analogous procedures, acquire and plot intensities of light incident in the eyes for units of JNDINDEX, 3, 4, 5, . . . , are repeated until a luminance value that the video display apparatus 100 can output or the necessary number of gradations is reached. Accordingly, a relation between JNDINDEX and the light emitting luminance illustrated in FIG. 5 is acquired. As a result, JNDINDEX is specified as an increment such that the perceived quantity of the difference in luminance becomes even.

As described above, the light emitting luminances of the display apparatus corresponding to the respective gradation values as illustrated in FIG. 18A are calculated. These results are assigned to the 10-bit gradation values 0-1023 for the respective pixels in the video signal processing unit 104 as illustrated in FIG. 6, thereby forming the final gradation-display luminance converting characteristics in the video display apparatus 100. In Example 3, the characteristics illustrated in FIG. 18A are output as the look up table (LUT) of the light emitting luminance characteristics to the video signal processing unit 104.

Likewise, as illustrated in FIG. 18B, light emitting luminance characteristics in the different adapting luminance are calculated. Here, the adapting luminance X represents the light emitting luminance characteristics in a case of the state of adaptation in the environment with low light. The nearer the adapting luminance Z is reached, the higher the luminance of the environment of the state of adaptation is represented. The processing of the unit setting light emitting luminance characteristics 203 is here finished. The processing proceeds to the video signal processing unit 204.

<Video Signal Processing Unit>

The video signal processing unit (gradation converter) 204 performs signal processing, such as image quality adjustment, based on the video signal of the input image to be input and the light emitting luminance characteristics set by the unit setting light emitting luminance characteristics 203, and outputs the result to the video display unit (image displaying unit) 205. As illustrated in FIG. 6, the video signal S is converted into the input signal P according to the video signal S-input signal level P converting characteristics illustrated in the first quadrant. Based on the input signal P, a data corresponding to the luminance B is subsequently generated according to the light emitting luminance characteristics Fy illustrated in the second quadrant, causing the video display unit 205 to emit light at the luminance B.

The video signal processing unit 204 may read the gradation values for the respective pixels from the video signal transmitted as serial data using a DSP (digital signal processor) internally including a RAM, and perform gradation conversion processing for correction to acquire a gradation value in which the light emitting luminance characteristics have been reflected.

The image data of input images formed in various formats may be reproduced as gradation data for the respective pixels and converted into gradations in which the light emitting luminance characteristics (gradation-luminance of the displaying conversion characteristics) of this example have been reflected, and image processing for conversion into one piece of image data may be performed. In this case, the video signal processing unit 204 and the ambient light measuring unit 201 may be configured as one image processing apparatus independent from the video display unit 205, and the processing may be performed.

As described above, Example 3 uses the luminance difference discriminability threshold characteristics (FIG. 16C) acquired by experiment on the case of adaptation to various luminance environments. According to this, the gradations without discontinuity/crush/saturation in perception can be reproduced over the entire light emitting luminance range (dynamic range) of the video display apparatus 200. The image display apparatus capable of outputting a video having light emitting luminance characteristics according to human visual characteristics in various luminance environments can be provided.

Further, the luminance difference discriminability threshold characteristics varying according to environmental luminances may be represented by the function in Equation 11, and the coefficients A, B and C may be stored, thereby enabling the light emitting luminance characteristics to be easily calculated in an unknown environmental luminance.

### Example 4

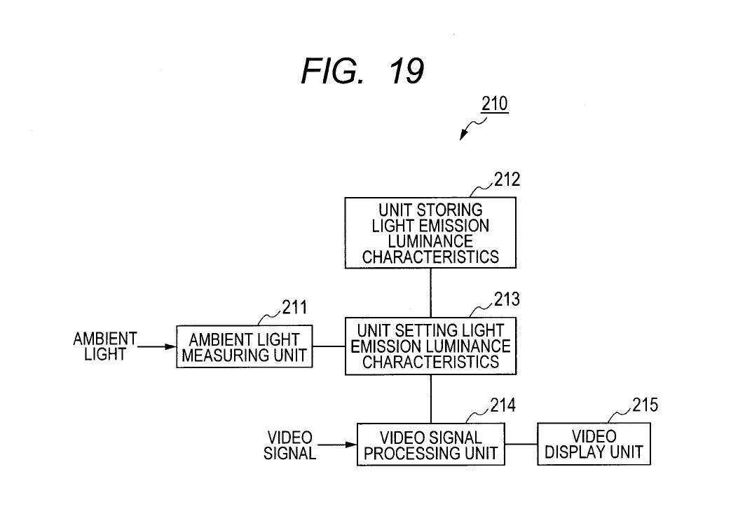

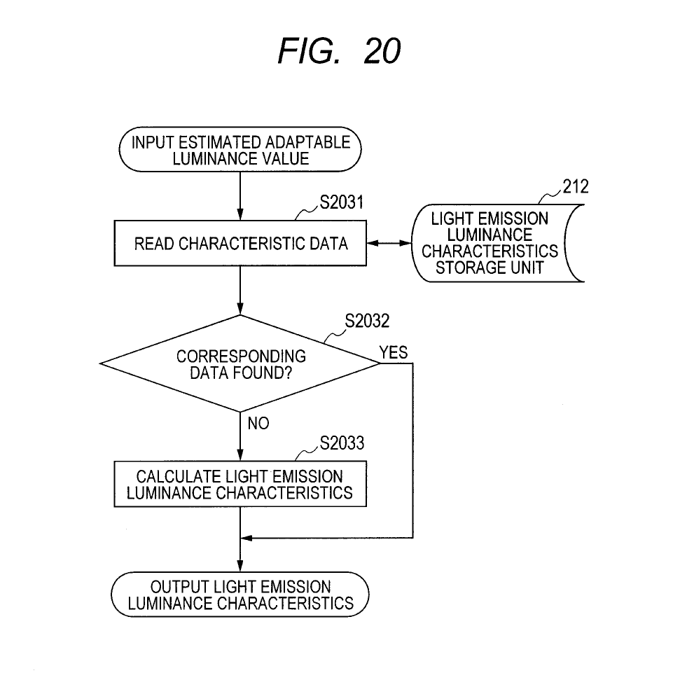

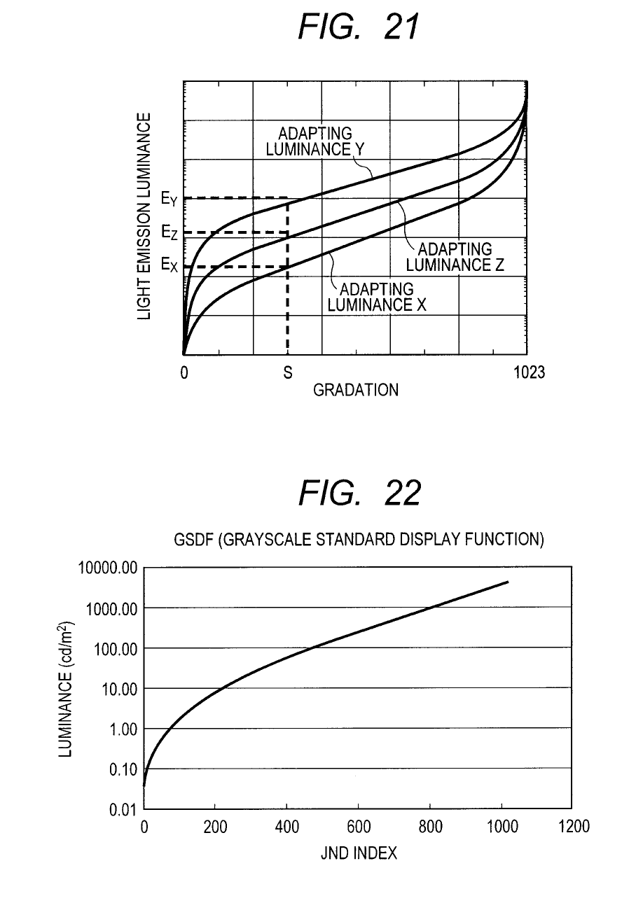

FIG. 19 is a block diagram illustrating a configuration of video display apparatus according to Example 4. FIG. 20 is a flowchart illustrating an operation of a unit setting light emitting luminance characteristics according to Example 4. FIG. 21 is a diagram illustrating a method of interpolating light emitting luminance characteristics according to Example 4.

In Example 4, a plurality of light emitting luminance characteristics for converting the gradations of an image into the luminance of the displaying of the image is preliminarily held. What corresponds to the luminance environment is selected from among the plurality thereof and used. In Example 3, the light emitting luminance characteristics are calculated from the luminance difference discriminability threshold characteristics every time. However, in comparison thereto, it is useful to hold the light emitting luminance characteristics themselves as a look up table (LUT), for the sake of high speed processing.

As described in FIG. 19, the video display apparatus 210 is an image display apparatus that receives a video signal from a computer and display luminances of the image on a screen. The ambient light measuring unit 211 measures the intensity of viewing environmental light around the video display apparatus. As with Example 3, the adapting luminance is estimated from the illuminance measured by the sensor arranged adjacent to the display of the video display apparatus 210.

As with Example 3, the video signal processing unit 214 performs processing of light emitting luminance characteristics using the light emitting luminance characteristics illustrated in FIG. 6 and processing of another video signal, and outputs the signal to the video display unit 215. The video signal processing unit 214 performs signal processing, such as image quality adjustment, based on the input video signal S and the light emitting luminance characteristics set by the unit setting light emitting luminance characteristics 213, and outputs the signal to the video display unit 215.

A unit storing light emitting luminance characteristics 212 stores the light emitting luminance characteristics that correspond to the luminance difference discriminability threshold characteristics when humans are adapted to various environmental light intensities. The unit storing light emitting luminance characteristics 212 stores the luminance of light incident in the eyes calculated by the experiment and the light emitting luminance characteristics calculated according to the method described in Example 3 using the value of luminance difference discriminability threshold contrast.

The unit setting light emitting luminance characteristics 213 sets the light emitting luminance characteristics corresponding to the viewing environmental light around the video display apparatus 210. The unit setting light emitting luminance characteristics 213 reads the light emitting luminance characteristics corresponding to the estimated adapting luminance value acquired by the ambient light measuring unit 211 from the unit storing light emitting luminance characteristics 212, and sets the light emitting luminance characteristics. An operation of the unit setting light emitting luminance characteristics 213 will be described in detail with reference to the flowchart of FIG. 20.

As illustrated in FIG. 20 with reference to FIG. 19, in step S2031, the look up table (LUT) of the light emitting luminance characteristics in the adapting luminance matching therewith are read based on the estimated adapting luminance value acquired by the ambient light measuring unit 211 from the unit storing light emitting luminance characteristics 212. If the matched data exists (YES in S2032), the read light emitting luminance characteristics are output and the processing is finished.

However, the data of the light emitting luminance characteristics matching with the adapting luminance does not necessarily exist. Therefore, without such matched data (No in S2032), each of data most similar to the bright and dark directions with respect to the adapting luminance Z measured by the ambient light measuring unit 211 is read one after another. In step S2033, the look up table (LUT) of the two light emitting luminance characteristics is read, the light emitting luminance characteristics in the unknown adapting luminance Z are estimated according to a linear interpolation from the light emitting luminance characteristics in the two adapting environments having been read.

As illustrated in FIG. 21, it is provided that the light emitting luminance characteristics is measured and stored with respect to the adapting luminance X and the adapting luminance Y as described in Example 3 corresponding to 10-bit gradations of the input signal. Here, a case where the adapting luminance Z estimated by the illuminance measured by the ambient light measuring unit 211 is a value between the adapting luminance X and the adapting luminance Y is considered. A case of acquiring a light emitting luminance in a certain video signal value S is then considered, and the light emitting luminances in the adapting luminance X and the adapting luminance Y are specified as E_{X} and E_{Y}, respectively. According thereto, the light emitting luminance E_{Z} in the adapting luminance Z can be acquired by the following equation.

$$\begin{matrix}[ Math . 15 ] & \\ {E}_{z} = ( {E}_{Y} - {E}_{X} ) \times \frac{{log}_{10} ( Z - X )}{{log}_{10} ( Y - X )} & \end{matrix}$$

Further, analogous calculations for the entire video signal values are performed using Equation 8. Accordingly, the look up table (LUT) of the light emitting luminance characteristics in the visual environment of the unknown adapting luminance Z can be created. The created table of the light emitting luminance characteristics is output, and the processing of the unit setting light emitting luminance characteristics 213 is finished.

Here, the light emitting luminance characteristics in the visual environment are estimated by interpolation. Accordingly, experimental data in the luminance environment with the lowest light and experimental data in the brightest luminance environment can be prepared. However, in one of a case where it is darker than the lowest adapting luminance in the previous experiments and a case where it is brighter than the highest adapting luminance in the previous experiment, the characteristics may be acquired by extrapolation.

Instead of estimating the light emitting luminance characteristics, a threshold is provided and then adapting luminance of the stored data closest to adapting luminance can be used in place thereof if the luminance is within the threshold. If experimental data in multiple adapting environments is stored, the need for the estimation in step S2032 is negated, thereby allows the processing to be performed faster.

Thus far, the processing of the unit setting light emitting luminance characteristics 213 is finished. The processing proceeds to the video signal processing unit 214.

In Example 4, the method of calculating the light emitting luminance characteristics described in Example 3 is used, and preliminarily calculates, stores and holds the look up table (LUT) of the light emitting luminance characteristics, thereby enabling the processing to be performed faster.

<Common Logarithm>

FIGS. 25A to 25C are diagrams illustrating a reason for using common logarithms.

FIGS. 25B and 25C illustrate representations in real numbers with respect to the ordinate of the gradation-display luminance converting characteristics (301) in Example 3 illustrated in FIG. 25A. FIG. 25C is a diagram where FIG. 25B is partially enlarged. Each diagram illustrates the Weber-Fechner linear equation (300) and the GSDF characteristics of DICOM (305) based thereon.

In the real number axis representations illustrated in FIGS. 25B and 25C, it is difficult to discriminate three functions from each other. In contrast to FIG. 25A, three types of conversion characteristics cannot be intuitively discriminated from each other. As recited in NPL 1, according to evaluation of the luminance of the displaying using the common logarithm, a proportional relation between the common logarithm of the luminance of the displaying and the increments of the luminance sense appears in the intermediate gradation range.

However, after differences between the three functions are recognized theoretically and experimentally, it is easy to create an approximate expression in a real number axis representation and to operate gradation-display luminance converting characteristics (301) of Example 3. The image display apparatus may use gradation-display luminance converting characteristics assigning the real number value of the luminance of the displaying to the gradation value. A gradation-display luminance converting characteristics having an effect similar to that of Example 3 may be created based on another operational equation by a curve y=xn (n=0.3) representing visual characteristics analogous to the common logarithm.

Accordingly, the present invention is not limited to examples that create the gradation-display luminance converting LUT through the operation using the common logarithm. Instead, the present invention includes a conversion processing using a gradation-display luminance converting LUT acquired using another operational equation and real number values. The operation may be replaced with any one of a data conversion using a data table, an interpolation operation of at least two functions and operations using a function similar to the common logarithm and an approximate expression. In any case, the present invention includes examples capable of acquiring gradation-display luminance converting characteristics similar to those using conversing equation created through an operation using the common logarithm.

This application claims the benefit of Japanese Patent Application Nos. 2009-270631, filed Nov. 27, 2009, and 2009-270632, filed Nov. 27, 2009, which are hereby incorporated by reference herein in their entirety.

1. An image display apparatus comprising:
a display unit; and
a gradation conversion unit for a conversion processing to correlate a gradation of an input image with a luminance of a displaying by the display unit, according to a predetermined conversion characteristics, wherein
the gradation conversion unit performs the conversion processing such that, when the luminance of the displaying by the display unit is evaluated based on a common logarithm, in a high luminance and gradation range, as the gradation of the input image increases toward a maximum value, a variation of the luminance of the displaying by the display unit based on the common logarithm corresponding to a variation of the gradation of the input image increases, so as to be shifted from a relation between the gradation of the input image and the luminance of the displaying in an intermediate luminance and gradation range.

2. The image display apparatus according to claim 1, wherein
the gradation conversion unit performs the conversion processing such that, in a low luminance and gradation range, as the gradation of the input image decreases toward a minimum value, the variation of the luminance of the displaying by the display unit based on the common logarithm corresponding to the variation of the gradation of the input image increases, so as to be shifted from a relation between the gradation of the input image and the luminance of the displaying in the intermediate luminance and gradation range.

3. The image display apparatus according to claim 2, wherein
the gradation conversion unit performs the conversion processing, in the intermediate luminance and gradation range, locally, to increase the variation of the luminance of the displaying by the display unit based on the common logarithm corresponding to the variation of the gradation of the input image.

4. The image display apparatus according to claim 3, further comprising
an environmental light measuring unit for measuring an ambient light, wherein,
as the ambient light increases, in the intermediate luminance and gradation range, the gradation conversion unit performs the conversion processing to suppress the locally increasing of the variation of the luminance of the displaying by the display unit based on the common logarithm.

5. The image display apparatus according to claim 1, wherein
the gradation conversion unit performs the conversion processing such that the maximum value of the gradation corresponds to the maximum luminance value displayable by the display unit.

6. The image display apparatus according to claim 1, wherein
the relation between the gradation of the input image in the intermediate gradation range and the luminance of the displaying in the common logarithm is based on a proportional relation,
the gradation conversion unit performs the conversion processing such that, when a luminance difference discriminable visually calculated based on the common logarithm is defined as a discriminability threshold luminance, a plurality of gradations between the maximum and minimum values of the gradations are related to the luminance values of the displaying at equal interval of the discriminability threshold luminance.

7. An image processing apparatus comprising:
a gradation conversion unit for converting an input image according to a predetermined conversion characteristics into an image to be displayed on a predetermined display unit to correlate a gradation of an input image with a luminance of a displaying by the display unit, wherein
the gradation conversion unit performs the conversion processing such that, when the luminance of the displaying by the display unit is evaluated based on a common logarithm, in a high luminance and gradation range, as the gradation of the input image increases toward a maximum value, a variation of the luminance of the displaying by the display unit based on the common logarithm corresponding to a variation of the gradation of the input image increases, so as to be shifted from a relation between the gradation of the input image and the luminance of the displaying in an intermediate luminance and gradation range.

8. The image display apparatus according to claim 1, further comprising
an environmental light measuring unit for measuring an ambient light, wherein,
as the ambient light increases, in a high luminance and gradation range, the gradation conversion unit performs the conversion processing to suppress the increasing of the variation of the luminance of the displaying by the display unit based on the common logarithm.

9. The image display apparatus according to claim 8, wherein
the gradation conversion unit performs the conversion processing such that, as the gradation of the input image increases toward a maximum value, the variation of the luminance of the displaying by the display unit based on the common logarithm corresponding to the variation of the gradation of the input image increases, so as to be shifted from a relation between the gradation of the input image and the luminance of the displaying in the intermediate luminance and gradation range, and
the gradation conversion unit performs the conversion processing to suppress the shifting from the relation in the high luminance and gradation range, as the ambient light increases.

10. The image display apparatus according to claim 9, wherein
the gradation conversion unit performs the conversion processing such that, as the gradation of the input image decreases toward a minimum value, the variation of the luminance of the displaying by the display unit based on the common logarithm corresponding to the variation of the gradation of the input image increases, so as to be shifted from a relation between the gradation of the input image and the luminance of the displaying in the intermediate luminance and gradation range, and
the gradation conversion unit performs the conversion processing to increase the shifted from the relation in the low luminance and gradation range, as the ambient light increases.

11. The image display apparatus according to claim 10, wherein
the gradation conversion unit performs the conversion processing, as the ambient light increases to increase the shifting from the relation between the gradation of the input image and the luminance of the displaying in the whole luminance and gradation range.

12. The image display apparatus according to claim 8, wherein
the gradation conversion unit performs the conversion processing such that the maximum value of the gradation corresponds to the maximum luminance value displayable by the display unit.

13. The image display apparatus according to claim 8, wherein
the relation between the gradation of the input image in the intermediate gradation range and the luminance of the displaying in the common logarithm is based on a proportional relation,
the gradation conversion unit performs the conversion processing such that, when a luminance difference discriminable visually calculated based on the common logarithm is defined as a discriminability threshold luminance, a plurality of gradations between the maximum and minimum values of the gradations are related to the luminance values of the displaying at equal interval of the discriminability threshold luminance.

14. The image processing apparatus according to claim 7, further comprising
an environmental light measuring unit for measuring an ambient light, wherein,
as the ambient light increases, in a high luminance and gradation range, the gradation conversion unit performs the conversion processing to suppress the increasing of the variation of the luminance of the displaying by the display unit based on the common logarithm.
